(19) United States
(12) Patent Application Publication
(10) Pub. No.: US 2012/0088148 A1
(43) Pub. Date: Apr. 12, 2012

(54) MAGNETIZED BATTERY CATHODES

(75) Inventors: Johna Leddy, Iowa City, IA (US); Perry Motsegood, North Liberty, IA (US)

(73) Assignee: The University of Iowa Research Foundation, Iowa City, IA (US)

(21) Appl. No.: 13/270,071

(22) Filed: Oct. 10, 2011

Related U.S. Application Data
(60) Provisional application No. 61/391,914, filed on Oct. 11, 2010.

(51) Int. Cl. H01M 4/50; H01M 10/04; H01M 6/04; H01M 4/04; H01M 10/26; H01M 4/62

(52) U.S. Cl. 429/207; 429/209; 429/224; 429/232; 429/217; 29/623.1

(57) ABSTRACT

The present invention provides a magnetized cathode mixture material comprising a ferromagnetic material, an electroactive material, and an electrolyte.

### CROSS REFERENCES TO RELATED APPLICATIONS

The Present Application claims the benefit of U.S. Provisional Patent Application No. 61/391,914, filed Oct. 11, 2010. The content of this U.S. Provisional Patent Application is hereby incorporated herein in its entirety.

### STATEMENT OF GOVERNMENT SUPPORT

This work was funded in part by grant no. 0809745 from the National Science Foundation. The United States Government may have certain rights in the invention.

### INTRODUCTION

Since the 1960's, alkaline batteries, also known as alkaline cells, have served as an energy source that is both economical and reliable. The growth of portable technology has spurred the demand and use of portable batteries, which has turned the portable battery into a multi-billion dollar industry. The growth of the industry and sales markets has required manufacturers to continuously research new methods for improving battery life and energy output. Alkaline batteries that feature a zinc/manganese dioxide (Zn/MnO₂) couple are the most common type of portable battery. Because the Zn/MnO₂ alkaline battery is inexpensive and relatively non-toxic, it is excellent for consumer use.

On the most fundamental level, a battery is a portable source of energy that comprises three components: an anode, a cathode, and an electrolyte. The anode serves as the electron source of the battery and is denoted as negative. The cathode is the electron sink and is marked as positive. The electrolyte then serves as a medium for flow of ionic charge between the anode to the cathode, thereby completing a circuit of ionic and electronic conductors.

The first batteries created were created in the mid-1800's and were primary in nature. Primary batteries are not rechargeable and thus provide only a single discharge. They are often manufactured in smaller cans and are less expensive than many rechargeable systems such as Li-ion, thus making them commercially viable and economical for consumers. Primary batteries provide a high energy density and are disposable.

Alkaline manganese cells are the most common form of alkaline cells produced commercially because they provide a long service life for high energy drain devices like toys and portable electronics in a primary battery. Open circuit voltages for these types of cells are approximately 1.55 V. The cathode of the battery is where reduction occurs. Thus, in alkaline manganese cells the MnO₂ in the cathode gains electrons and is reduced to form Mn(III) species and then in a second electron transfer step to Mn(OH)₂, according to the following equations:

MnO₂+H₂O+e⇄MnOOH+OH⁻

MnOOH+H₂O+e⇄Mn(OH)₂+OH⁻

In current commercial cells, the battery is typically anode limited and the second reaction is not part of the useful cell discharge. The energy provided by the second discharge is much less than that provided by the first because of the lower potential. The cathode of alkaline manganese dioxide cells is usually manufactured with MnO₂, graphite, and other binders, catalysts, and porosity enhancers, along with electrolyte. Typically, the electroactive cathode material is electrolytic manganese dioxide (EMD), which is prepared from the electrolysis of hot MnS0₄ at an anode. Material so prepared reduces with a good performance, for example, in alkaline electrolyte in an alkaline cell. EMD is very porous, which provides a high surface area for reduction.

At the anode, Zn loses electrons and is thus oxidized to Zn(OH)₂. The following equation details this chemical reaction within the battery:

Zn+2OH⁻⇄Zn(OH)₂+2e

The anode usually includes zinc metal and smaller amounts of zinc oxide, a gelling agent, and electrolyte. In commercial batteries, the reaction is usually “zinc limited,” that is to say that the amount of zinc present in the cell controls the power output of the battery, because after the zinc is completely oxidized, the battery is depleted. However, there are cases where the reaction is “manganese dioxide limited”, that is the zinc in the anode is supplied in excess so as not to limit the reaction.

### BRIEF DESCRIPTION OF THE FIGURES

FIG. 1 illustrates components of the battery and clamshell structure used to test a battery, not drawn to scale. For batteries tested under Example 1, the dimensions of the cathode are 8.2 mm diameter by 1.3 mm in height. The nylon ring insulator has an inner diameter of 19 mm, an outer diameter of 29 mm, and a height of 6 mm. For batteries tested under Example 2, the dimensions of the cathode are 8.2 mm diameter by 1.0 mm in height. The ring insulator is made from Teflon® with an inner diameter of 12 mm, an outer diameter of 29 mm, and a thickness of 6 mm. The copper current collector was removed from the system.

FIG. 2A illustrates representative discharge plots using a C/3 rate for cathode material where 20 w/w % of 9 M KOH incorporated into the cathode mixture was allowed to rest for 24 hours prior to pressing the electrode pellet. The plots are Potential (Volts) versus Time (minutes). FIG. 2B is the energy (J/g EMD) versus potential calculated by integrating the area under FIG. 2A.

FIG. 3A illustrates representative discharge plots using a C/5 rate for cathode material where 20% w/w of 9 M KOH was incorporated into the cathode mixture and allowed to rest for 24 hours prior to pressing the electrode pellet. The plots are Potential (Volts) versus Time (minutes). FIG. 3B is the energy (J/g EMD) versus potential calculated by integrating the area under FIG. 3A.

FIG. 4A illustrates average discharge times versus voltage at a C/3 discharge rate for the batteries shown in FIG. 2A. FIG. 4B illustrates average total energies versus voltage for the corresponding data illustrated in FIG. 2B.

FIG. 5A illustrates average discharge times versus voltage at a C/5 discharge rate for batteries shown in FIG. 3A. FIG. 5B illustrates average total energies versus voltage for the corresponding data illustrated in FIG. 3B.

FIG. 6 illustrates a representative constant current discharge curve using a C/3 rate where the cathode mixture contains 5 w/w % KOH under conditions explained in Example 2. The plot is Potential (V) versus Time (min).

FIG. 7 illustrates a representative constant energy curves using a C/3 rate where the cathode mixture contains 5 w/w % KOH under conditions explained in Example 2. The plot is Energy (mWh) versus Potential (V).

FIG. 8 illustrates a representative constant current discharge curve using a C/5 rate where the cathode mixture contains 5 w/w % KOH under conditions explained in Example 2. The plot is Potential (V) versus Time (min).

FIG. 9 illustrates representative energy curves using a C/5 rate. The plot is Energy (mWh) versus Potential (V). The cathode contained 5 w/w % KOH under conditions explained in Example 2.

FIG. 10 illustrates a representative constant current discharge curve using a C/5 rate. The plot is Potential (V) versus Time (min). The cathode contained 0 w/w % KOH at the time of pressing.

FIG. 11 illustrates a representative energy curves using a C/5 rate. The plot is Energy (mWh) versus Potential (V). The cathode contained 0 w/w % KOH at the time of pressing.

FIG. 12 illustrates a statistical analysis of time to a given voltage with a discharge rate of C/3 for batteries containing 5 w/w % KOH electrolyte in the cathode mixture.

FIG. 13 illustrates a statistical analysis of energy at a given voltage with a discharge rate of C/3 for batteries containing 5 w/w % KOH electrolyte in the cathode mixture.

FIG. 14 illustrates a statistical analysis of time to a given voltage with a discharge rate of C/5 for batteries containing 5% w/w KOH electrolyte in the cathode mixture.

FIG. 15 illustrates a statistical analysis of energy at a given voltage with a discharge rate of C/5 and 5 w/w % KOH electrolyte in the cathode mixture.

FIG. 16 illustrates a statistical analysis of time to a given voltage with a discharge rate of C/5 for batteries containing 0% w/w % KOH electrolyte in the cathode mixture.

FIG. 17 illustrates a statistical analysis of energy at a given voltage with a discharge rate of C/5 for batteries containing 0 w/w % KOH electrolyte in the cathode mixture.

### SUMMARY OF THE INVENTION

In a first aspect, the present invention provides a battery cathode mixture comprising a ferromagnetic material, manganese dioxide, and an electrolyte, wherein the mixture is magnetized.

In a second aspect, the present invention provides a method for manufacturing a magnetized battery cathode mixture, comprising forming a mixture comprising a ferromagnetic material, manganese dioxide, and an electrolyte, and magnetizing the mixture.

In a third aspect, the present invention provides a method for preparing a magnetized battery cathode mixture, comprising forming a mixture comprising an electroactive material and an electrolyte, and magnetizing the mixture.

### DEFINITIONS

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements. The word “or” means any one member of a particular list and also includes any combination of members of that list, unless otherwise specified.

The term “about” is used herein to mean approximately, roughly, around, or in the region of. When the term “about” is used in conjunction with a numerical range, it modifies that range by extending the boundaries above and below the numerical values set forth. Preferably, the term “about” is used herein to modify a numerical value above and below the stated value by a variance of 20 percent up or down (higher or lower).

The term “diameter” is used herein to mean the length of the longest straight segment connecting two points on the surface of a given object, wherein the entire length of the segment lies within said object.

The term “microparticle” is used herein to mean a particle between 10 nm and 100 μm in diameter.

The terms “% w/w” and “w/w %” are both intended to mean the concentration of a given component of composition expressed as the percentage by mass of the component. For example, in a composition obtained by adding 5 g of sugar to 45 g of water, the w/w % concentration of sugar in the composition is equal to [5/(5+45)]×100=10 w/w %. In the context of cathode and anode mixtures, unless otherwise indicated, concentrations are those at the time of pressing, that is at the time a mixture is placed in a die for pressing into pellets or other shapes to be included in a battery cathode or anode.

The term “cathode” is used herein to mean the electrode of a battery which receives current (electrons) when the battery discharges such that the electroactive material in the battery is reduced.

The term “anode” refers to the other electrode in the battery. It is necessary to complete the circuit and to provide electrons to the cathode so as to reduce the electroactive material. In commercial alkaline manganese primary batteries, the anode is made of zinc. In the design of alkaline manganese primary batteries, the usual configuration is that zinc is the limiting reagent and the manganese dioxide is provided in slight stoichiometric excess.

The term “electroactive material” is used herein to mean a material that is in contact with the cathode of a battery and is reduced, thereby acquiring electrons, when the battery discharges. For example, MnO₂ is the electroactive material in alkaline manganese batteries because it acquires electrons from the cathode and undergoes reduction to Mn(OH)₂ as the battery discharges.

The term “electrolyte” is used herein to mean a material comprising ions that render the material ionically conductive. The most typical electrolyte is an ionic solution, but dry electrolytes, gel electrolytes, molten electrolytes and solid electrolytes are also possible. Furthermore, some gases may act as electrolytes under conditions of high temperature or low pressure. In batteries, electrolytes are used to carry ionic current between the electrodes. Commonly, battery electrolytes are solutions having water or organic solvents as solvent and ionic species or species that ionize following dissolution, such as acids, bases or salts, as solutes. Such solutions are also known as electrolyte solutions. Electrolyte solutions can also result from the dissolution of some biological (e.g., DNA, polypeptides) and synthetic polymers (e.g., polystyrene sulfonate), termed polyelectrolytes, which contain charged functional groups. The later are common electrolytes in batteries and other electrochemical energy systems.

The term “separator” refers to a barrier between the electrodes that is ion permeable. The purpose of the separator is to prevent the electroactive components of the anode and cathode from mixing directly to thereby discharge the battery. To allow completion of the battery circuit, the separator must allow ionic contact between the electron conductors, the electrodes.

The term “samarium cobalt” is used herein to mean a material comprising samarium and cobalt. Typical samarium cobalt materials include “Series 1:5” samarium-cobalt magnet alloys, also written as SmCo₅, which are characterized by having one atom of rare earth samarium for every five atoms of cobalt, and “Series 2:17” alloys, also written as Sm₂Co₁₇.

The terms “neodymium magnet” and “NdFeB magnet” are interchangeably used herein to mean a magnet comprising neodymium, iron, and boron. Additional metallic components may be present in NdFeB magnets.

The term “Alnico” is used herein to refer to iron alloys which in addition to iron comprise aluminum (Al), nickel (Ni) and cobalt (Co), hence the acronym “al-ni-co.”

The term “magnetized material” is used herein to refer to a material, such as a battery cathode mixture, that has been subjected to an external magnetic field of sufficient intensity and for a sufficient period of time to establish a stable magnetic moment following removal of the external magnetic field.

### DESCRIPTION OF THE INVENTION

The present invention is based on the discovery that the addition of a ferromagnetic material to the cathode of an alkaline manganese battery, followed by magnetization of the cathode, improves battery performance with increased energy at given voltages, increased power at a given voltage, and increased discharge capacities. A more efficient electron transfer process yields greater energy output that translates to a more efficient battery that maintains higher voltages for longer periods of time at a given current. Without being bound to any particular theory, it is believed that the increased magnetic field due to the presence of the ferromagnetic material increases electron transfer efficiency in electroactive materials that includes paramagnetic materials such as the MnO₂ present in the cathode of alkaline manganese batteries. A higher percentage of the MnO₂ is thus reduced within the battery, leading to greater power output.

Accordingly, in one aspect, the present invention provides novel magnetized battery cathode mixtures comprising a ferromagnetic material, an electroactive material, and an electrolyte. In the context of the present invention, ferromagnetic materials are understood to also include ferrimagnetic materials. Representative ferromagnetic materials include, for instance, samarium cobalt (such as SmCo₅ or Sm₂Co₁₇), neodymium magnet, Alnico, ferrites (such as Sr-ferrite or MnOFe₂O₃), magnetite (Fe₃O₄), and ferromagnetic materials that comprise manganese (such as MnSb, MnBi, or MnAs). The amount of ferromagnetic material is preferably 1 to 20 w/w %, more preferably 2.5 to 10% w/w %, and most preferably 4 to 6% with respect to the entire cathode mixture. The ferromagnetic material is preferably distributed throughout the cathode in a manner that maximizes the impact of the magnetic field exerted throughout the cathode material. This may be accomplished, for example, by having the ferromagnetic material in the form of microparticles that are evenly distributed throughout the cathode matrix, although configurations can be used in which the magnetic particles are near the electroactive material but in separate sections of the electrode structure.

Preferably, the microparticles have an average diameter of about 100 nm to about 10 μm, and more preferably of about 500 nm to about 1.5 μm. The microparticle diameter should be large enough to allow for the formation of magnetic domains within the microparticles. For instance, if microparticles of a given material tend to lose their ferromagnetism at diameters smaller than 200 nm, then microparticles having a diameter of 200 nm or larger are preferred; smaller particles may also be used, but it is preferable that, when mixed with the other components of the cathode, they are able to form clusters where the magnetic dipoles of the individual particles are aligned together to form magnetic moments. If deemed advantageous, for example to prevent unwanted reactions with other components of the cathode, the microparticles may be provided with a coating according to methods commonly used in the art.

The electroactive material may be chosen from those commonly used in battery cathodes, according the type of battery one intends to manufacture. Accordingly, for standard alkaline batteries, the material of choice is usually manganese dioxide (MnO₂), and electrolytic manganese dioxide (EMD) is particularly preferred. The amount of electroactive material is preferably 50 to 95 w/w %, more preferably 60 to 90 w/w %, and most preferably 65 to 85 w/w % with respect to the entire cathode mixture.

There are no specific restrictions regarding the electrolyte, provided that it is compatible with the other components of the cathode and serves the function of carrying charge to and from the cathode. In alkaline batteries, for instance, the electrolyte is usually an aqueous solution of one or more bases, such as KOH, LiOH, NaOH, and transition metal hydroxides. In this regard, there is also no specific limitation regarding the base concentration, which is preferably 0 to 40 w/w %, and more preferably 5 to 25% w/w %, with respect to the entire cathode mixture. In applications where aqueous solutions are not advisable, for example if the battery potential is higher than that at which aqueous solutions can electrolyze, solutions based on organic solvents are preferred. For instance, preferred electrolytes for lithium-ion batteries comprise lithium salts, such as LiPF₆, LiBF₄ or LiClO₄ in an organic solvent, such as ethylene carbonate, dimethyl carbonate, and diethyl carbonate.

If desired, the cathode mixture may be prepared without electrolyte and added to the battery cathode as a “dry” cathode mixture, also referred to as a “cathode mixture having 0 w/w % electrolyte.” Electrolyte is then added to the cathode mixture following pressing and placement of the mixture in the battery, for example by diffusion from other parts of the battery such as the separator or anode.

The cathode mixture is magnetized, for example as a result of magnetization by means of an electromagnet or a permanent magnet. When the ferromagnetic material is in the form of microparticles, it is preferable that the magnet strength be sufficient to induce magnetization, but not too strong and pull the ferromagnetic particles out of the cathode material matrix, creating an uneven distribution within the mixture.

The cathode mixture may comprise additional, optional components, such as conductive additives for improving the electric conductivity, binders for improving mechanical strength and compressibility, lubricants, additives to prevent corrosion, additives to control cathode porosity, or catalysts to facilitate electron transfer from the MnO₂ to the Zn in the anode, such as, for example, mercury or other catalysts known to those skilled in the art. In alkaline batteries and lithium-ion batteries, for instance, powders of metallic or carbon-based additives, such as conductive carbon black (CCB) and graphite, are usually added to improve conductivity and as binders. In particular, particles of high-purity synthetic graphite are a preferred additive for alkaline batteries as they are believed to provide a conduction pathway for electrons consumed by the reaction at the cathode. The amount of graphite is preferably sufficient to diminish the resistivity of the cathode, but not so high as to lead to unacceptable drops in the amount of the electroactive material(s). Preferably, the amount of graphite is 5 to 25 w/w %, more preferably 10 to 20 w/w %, and most preferably 12 to 18 w/w % with respect to the entire cathode mixture.

Preferred binders include polymers with a high resistance to solvents, acids and bases. Example polymers include fluorocarbons such as PVF (polyvinylfluoride), PVDF (polyvinylidene fluoride), PTFE (polytetrafluoroethylene), PCTFE, (polychlorotrifluoroethylene), PFA (perfluoroalkoxy polymer, “Teflon®”), FEP (fluorinated ethylene-propylene), ETFE (polyethylenetetrafluoroethylene), ECTFE (polyethylenechlorotrifluoroethylene), FFPM/FFKM (Perfluorinated Elastomer, Perfluoroelastomer), FPM/FKM (Fluorocarbon [Chlorotrifluoroethylenevinylidene fluoride]), PFPE (Perfluoropolyether), Nafion®, and perfluoropolyoxetane. PTFE is particularly preferred. Binders other than fluorocarbons, such as carboxymethylcellulose (CMC), may also be used. The amount of binder is preferably is 0 to 10 w/w %, more preferably 0.5 to 5% w/w %, and most preferably 1 to 3 w/w % with respect to the entire cathode mixture.

The magnetized cathode mixture of the invention may be included in the cathode of a battery, and the battery may be included in an electric or electronic device. Batteries comprising the cathode mixture of the invention are particular indicated for high-drainage devices, such as toys, laptop computers, and cordless power tools.

In a second aspect, the present invention provides methods for manufacturing a magnetized battery cathode mixture. In a representative example, a cathode mixture is prepared by combining ingredients comprising a ferromagnetic material, an electroactive material, an electrolyte, and optional components such as such as conductive additives, binders, lubricants, corrosion preventers, and additives to control cathode porosity. When the electrolyte is an electrolyte solution, its individual components, i.e. the solvent and solute, may be added separately to the other components of the cathode mixture. Alternatively, and more preferably, the solvent and solute are first combined to yield the electrolyte solution which is then blended with the other components of the cathode mixture.

After the ingredients have been combined, the resulting mixture can then be pressed or compacted into cathode preforms. For example, conventional presses and suitable dies are known in the art to apply selected pressures to compress the electrode structure, although presently non-conventional approaches can be similarly used. The preforms can comprise a pellet shape, a hollow cylindrical shape, a plate shape, a sheet shape, disc shape, or other shapes.

The cathode mixture is preferably magnetized by means of an electromagnet or a permanent magnet for a sufficient duration of time to yield a magnetized cathode mixture. The magnetization step may occur prior to, during, or after the cathode mixture is pressed or compacted into cathode performs, and may take place after the mixture is placed in a battery cathode. The magnetization step may also occur prior to, during, or after the electrolyte is added to the mixture. Varying magnet strengths and time durations may be tested in order to optimize results and maximize consistency. When the ferromagnetic material is in the form of microparticles, it is preferable that the magnet strength be sufficient to induce magnetization, but not too strong and pull the ferromagnetic particles out of the cathode material matrix, creating an uneven distribution within the mixture.

Additional rounds of re-magnetization may be applied to the battery if this is found to be beneficial to its performance. If the battery is left in long-term storage, for example, it may be re-magnetized at fixed intervals, for instance once monthly. Re-magnetization may also be carried out following instances where the battery is subjected to long discharge times at high loads.

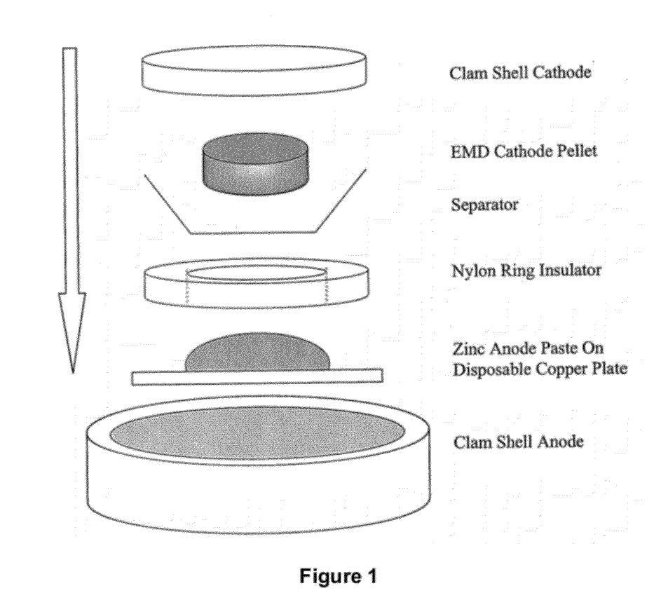

The cathode mixture, may be put into electrical contact with the cathode of a battery. In clam shell batteries (also known as “button” batteries), for instance, the cathode mixture is formed into pellets that are sandwiched between the cathode and separator, where the separator prevents mixing of the anode and cathode materials while conducting ions between the two (FIG. 1). In cylindrical batteries, the cathode mixture may be pressed into the can or deposited as pre-molded rings sandwiched between the separator and cathode.

There are no particular restrictions on the types of anodes that may be included in a battery containing the cathodes of the invention, provided that the anode is compatible with the chemistry of the cathode and that the desired current and powder are provided when the battery discharges. For alkaline manganese batteries, anodes comprising a zinc powder (zinc anodes) are usually preferred.

With regard to the individual ingredients of the cathode mixture, in representative ferromagnetic materials include, for instance, samarium cobalt (such as SmCo₅ or Sm₂Co₁₇), neodymium magnet, Alnico, ferrites (such as Sr-ferrite or MnOFe₂O₃), magnetite (Fe₃O₄), and ferromagnetic materials that comprise manganese (such as MnSb, MnBi, or MnAs). The amount of ferromagnetic material is preferably 1 to 20 w/w %, more preferably 2.5 to 10% w/w %, and most preferably 4 to 6% with respect to the entire cathode mixture. Preferably, the ferromagnetic material is provided in the form of microparticles having an average diameter of about 100 nm to about 10 μm, and more preferably of about 500 nm to about 1.5 μm. Preferably, the particles have an average diameter large sufficient for the formation of magnetic domains. Smaller particles may be also be used, provided that they are able to form clusters where the magnetic dipoles of the individual particles are aligned together to form magnetic moments. The particles may be provided with a coating to prevent undesired reactions with other components of the cathode.

The electroactive material is preferably provided in the form of a powder, and is chosen on the basis of the type of battery for which the cathode mixture is produced. For standard alkaline batteries, a preferred material is manganese dioxide (MnO₂), and electrolytic manganese dioxide (EMD) is particularly preferred. The amount of electroactive material is preferably 50 to 95 w/w %, more preferably 60 to 90 w/w %, and most preferably 65 to 85 w/w % with respect to the entire cathode mixture.

When the electroactive material includes MnO₂, the electrolyte is preferably an aqueous solution of one or more bases, such as KOH, LiOH, NaOH, and transition metal hydroxides Aqueous solutions comprising KOH are particularly preferred. The aqueous solution concentration is preferably 0 to 40 w/w %, and more preferably 5 to 25% w/w %, with respect to the entire cathode mixture. If desired, the cathode mixture may be prepared without electrolyte and added to the battery cathode as a “dry” cathode mixture. Electrolyte is then added to the cathode mixture after pressing, for example by diffusion from other parts of the battery such as the separator or anode.

Additional optional components may include, for example, conductive additives for improving the electric conductivity, binders for improving mechanical strength and compressibility, lubricants, additives to prevent corrosion, and additives to control cathode porosity. In alkaline batteries and lithium-ion batteries, for instance, carbon-based additives, such as conductive carbon black (CCB) and graphite, are usually added to improve conductivity and as binders. In particular, high-purity synthetic graphite is a preferred additive for alkaline batteries. The amount of graphite is preferably sufficient to diminish the resistivity of the cathode but not so high as to lead to unacceptable drops in the amount of the electroactive material(s). Preferably, the amount of graphite is 5 to 25 w/w %, more preferably 10 to 20 w/w %, and most preferably 12 to 18 w/w % with respect to the entire cathode mixture. Preferred binders include polymers with a high resistance to solvents, acids and bases. Example polymers include fluorocarbons such as PVF, PVDF, PTFE, PCTFE, PFA, FEP, ETFE, ECTFE, FFPM/FFKM, FPM/FKM, PFPE, Nation®, and perfluoropolyoxetane. PTFE is particularly preferred. Binders other than fluorocarbons, such as carboxymethylcellulose (CMC), may also be used. The amount of binder is preferably is 0 to 10 w/w %, more preferably 0.5 to 5% w/w %, and most preferably 1 to 3 w/w % with respect to the entire cathode mixture.

The present invention is also based on the further discovery that, even in the absence of a ferromagnetic material, subjecting a cathode mixture to a magnetic field will increase the total energy output of a battery, yielding improved energy at given voltages, power at a given voltage, and discharge capacities. Without being bound to any particular theory, magnetization is believed to increase electron transfer efficiency in electroactive materials, even in the absence of a ferromagnetic material.

Accordingly, in a third aspect, the present invention provides for novel magnetized cathode mixtures produced by subjecting a cathode mixture to a magnetic field. The cathode mixtures of this third aspect comprise an electroactive material and an electrolyte, and are substantially free of ferromagnetic materials, i.e. they do not contain ferromagnetic materials in sufficient amounts to improve the energy output of batteries. The electroactive material is preferably a paramagnetic material, such as MnO₂. Additional, optional components may include conductive additives for improving the electric conductivity, such as graphite, binders for improving mechanical strength and compressibility, for example polymers such as PTFE, lubricants, additives to prevent corrosion, and additives to control cathode porosity.

In a representative example, a magnetized cathode mixture is prepared as follows. First a cathode mixture by mixing its ingredients. Subsequently, the cathode mixture is subjected to magnetization, for example by means of an electromagnet or permanent magnet. The cathode mixture may be formed into preforms suitable for the cathode of a battery, for example by pelletization, either prior, during, or following magnetization. Cathode mixture pellets may be easily magnetized by placement in the center of a toroidal-shaped magnet for a sufficient amount of time. Optionally, batteries comprising magnetized cathode mixtures may be subjected to cathode re-magnetization by means of a magnet.

### Example 1

To measure the effects of a ferromagnetic material within the cathode of a battery, a first “magnetically modified” cathode mixture and a second analogous but non-modified, or blank, cathode mixture were prepared. A first mixture of EMD (battery grade, Delta EMD, South Africa), synthetic graphite (Sigma-Aldrich, Mo.), polytetrafluoroethylene (PTFE) (Sigma-Aldrich), and aqueous KOH solution having a molarity of 9 M (Fisher Scientific) as electrolyte, was formed. Magnetic modification was achieved by including SmCo₅ (reaction grade, Alfa Aesar, Mass.) in the first mixture and magnetizing the mixture. Cathodes including both cathode mixtures, modified and unmodified, were assembled with a zinc anode to form batteries.

### Cathode Mixture Preparation

The reagents listed in the table below were mixed by mass to the following mass percentages. All reagents except 9 M KOH were in powder form and used as received. Powders were mixed first and rotated in a tumbler to ensure homogeneity. As detailed below, the only difference between the cathode mixtures was the exclusion of SmCo₅ that was substituted with EMD in the blank, non-modified cathode mixture. This increased the EMD content to 68 w/w % and decreased the samarium cobalt to 0 w/w %. All other reagents remained the same.

| | | Magnetically |
|---|---|---|
| | Blank | modified |
| Reagent | (w/w %) | (w/w %) |
| MnO₂ | 68 | 58 |
| Graphite | 10 | 10 |
| PTFE | 2 | 2 |
| SmCo₅ | — | 10 |
| KOH, 9M | 20 | 20 |

Once the powders were mixed, a small volume of electrolyte was blended in to generate the cathode mixture that was allowed to rest and equilibrate up to 48 hours. The cathode mixture was then transferred into a custom-made die, and 1.5 metric tons per cm² of force were applied with a hydraulic press for 30 seconds for three consecutive times, to yield pellets.

Cathode mixture magnetization was carried out by one of two methods. The first method included magnetizing by means of an electromagnet for about 10 seconds at a time in between presses. The electromagnet provided a strong magnetic field but often yielded inconsistent data. Without being bound to any particular theory, it is believed that this may be due to the magnetic field being too strong and pulling the ferromagnetic particles out of the cathode material matrix, creating an uneven distribution within the pellet.

The second magnetization method, based on the use of a neodymium magnet ring proved to be effective and gave more reliable results, possibly because the strength of the magnetic field exerted by the ring was lesser than that of the electromagnet. The dimensions of the ring magnet were outer diameter of 7.5 cm, inner diameter of 5 cm, and a height of 1 cm. Cathode mixture pellets that were magnetized with the ring magnet were removed from the pressing dye and placed in the center of the ring magnet for 60 seconds.

### Anode Mixture Preparation

A zinc anode mixture was prepared by mixing granulated zinc metal (Umicore, Belgium), zinc oxide (ZnO 99.7%, Strem Chemicals, Massachusetts), carboxymethylcellulose (CMC, Sigma-Aldrich) and an aqueous KOH 9 M solution mass to the mass percentages listed below. The reagents were used as received, and powder reagents were mixed first to ensure homogeneity.

| Reagent | w/w % |
|---|---|
| Zinc | 57 |
| ZnO | 1 |
| CMC | 4 |
| KOH, 9M | 38 |

Powder reagents were first mixed to ensure homogeneity, and the resulting dry mixture was combined with the KOH solution and allowed to rest for 15 minutes.

The mixtures above are listed to describe the components and corresponding weight fraction for the cathode mixture and anode mixture, respectively. During battery assembly was the stoichiometric ratio of zinc within the anode to MnO₂ within the cathode equal to 2:1 as based on total anode capacity versus cathode capacity. This is explained further in the calculation of experimental current section, below.

### Battery Preparation

A clam shell style battery canister (MTI Corporation, California) was used to house the two half-cells as they were assembled into a battery with two electrodes and a separator. The assembly, illustrated in FIG. 1, included a stainless steel apparatus insulated to maintain electrical separation of the anode and cathode. In some measurements, a thin disposable copper plate having a thickness of 0.127 mm thick (Strem Chemicals) was used as electrical contact between the anode mixture and clam shell to protect the clam shell from undue corrosion during discharge. The anode mixture rested directly on a copper plate and completed the anode portion of the battery. A nylon ring was then placed over the anode to maintain electrical insulation. Two layers of a cellulose based separator were wetted with 100 μL of KOH 9 M solution and served as the charge separator between the anode and cathode.

A pellet of magnetized cathode mixture was placed on top of the separator and then forced inside the insulating ring to achieve contact with the anode. The clam shell cathode was then secured into place to complete the battery. A PC-controlled battery analyzer (MTI Corporation) with independent channel capability measured voltage and current separately. Batteries were discharged at a constant rate based on individual theoretical maximum capacity, which was directly related to the mass of EMD within the cathode. To ensure that the system was quantifying only cathode effects, battery capacities were controlled by designating the cathode (EMD specifically) as the limiting reagent and utilizing excess zinc in the anode. Limitations of the anodes began to appear as the batteries discharged and voltages approached 0.8 V.

### Explanation of Alkaline Battery Performance

Two characteristics of a battery are the cell voltage and total energy, which is often referred to as “capacity” as expressed in amp-hours (Ah) or milliamp-hours (mAh). The theoretical cell voltage is a fundamental thermodynamic property governed by the Nernst equation, where E⁰ is the standard potential (V), R is the molar gas constant

$$( \frac{J}{mol \times K} ) ,$$

T is temperature in Kelvin, n is the number of electrons involved in the reaction, F is Faraday's constant

$$( \frac{C}{mol} ) ,$$

Cₒ and C_{R} are the concentrations of oxidized and reduced species, respectively.

$$E = {E}^{o} - \frac{RT}{n F} ln ( \frac{{C}_{o}}{{C}_{R}} ) \qquad ( 1 )$$

In the case of the zinc-manganese alkaline battery, zinc is oxidized to zinc oxide while EMD is reduced to MnOOH and then to Mn(OH)₂, where Mn(OH)₂ is generated as the second electron in the reduction process is accessed. In commercial batteries, the system is designed to be anode-limited and to only exploit the first electron in the reduction sequence for MnO₂. The reduction of MnO₂ occurs during separate electron transfer events from the +4 to +3 oxidation states and then to the +2 oxidation state.

MnO₂+H₂O+e⇄MnOOH+OH⁻

MnOOOH+H₂O+e⇄Mn(OH)₂÷OH⁻ (2)

Zinc is oxidized at the anode:

Zn(OH)₂+2e⇄Zn+2OH⁻ (3)

The overall chemical equation is:

MnO₂+Zn+2H₂O⇄Mn(OH)₂+Zn(OH)₂ (4)

The first electron of MnO₂ and the zinc provide a battery voltage of around 1.55V. Addition of magnetic particles does not affect the theoretical open circuit voltage or capacity of the battery from a stoichiometric perspective.

### Calculation of Experimental Current.

Battery discharge capacity as a function of EMD mass in the battery. Consequently, each battery has its discharge current for constant current discharge calculated based on the mass of EMD in the battery. The total capacity is set by limiting reagent, either zinc or EMD and the number of electrons available from the given mass of the limiting reagent. Energy within an electrode is calculated based on the ratio of the mass of reagent and the available energy per gram of reagent. Reported values for zinc and MnO₂ are 0.82 Ah/g and 0.616 Ah/g, respectively [8]. The w/w % of zinc in the anode is 57%, as set forth above, and the target mass is 0.2 g.

$$\frac{0.82 Ah}{g Zn} \times \frac{0.57 g Zn}{1 g of anode} \times 0.2 g of anode = 0.0935 Ah \qquad ( 5 )$$

The cathode mass is back-calculated based on the anode energy value and capacity from Eq. 5. The ratio of zinc to MnO₂ is 2:1 is provided with the objective of designing a cathode-limited system. The energy of the EMD cathode is calculated from the MnO₂ capacity per gram [8].

$$\begin{matrix}\frac{0.616 Ah}{g {MnO}_{2}} \times 0.9 \times \frac{0.58 g {MnO}_{2}}{1 g cathode} = \frac{0.322 Ah}{g cathode} for n = 2 electrons & ( 6 ) \\ \frac{0.0935 Ah}{2} \times \frac{g cathode}{0.322 Ah} = 0.1454 g cathode & ( 7 ) \\ 0.1454 g cathode \times \frac{0.322 Ah}{g cathode} \times \frac{1000 mA}{1 A} \times \frac{1 experiment}{3 h} = 15.6 mA for n = 2 electrons & ( 8 )\end{matrix}$$

Unlike zinc, MnO₂ is capable of sequential electron transfer events as it is reduced from Mn(IV) to Mn(III) and then Mn(III) to Mn(II). Because of energetic values being less during the second electron transfer (+3 to +2), the cathode capacity is halved to account for an n=1 process. Recalculation of the cathode capacity is then half of the value in Eq. 6, which then correlates to a discharge rate that is also halved, or 7.8 mA/g of EMD. The energy associated with a second reduction is small compared to the energy generated by the first reduction of manganese.

Batteries were discharged using a constant current calculated based on the theoretical capacity of the individual battery. These discharge rates are reported as C-rates, or capacity rates, and correspond to the theoretical capacity discharged over a given time interval. For example, a battery with a theoretical capacity of 30 mAh is discharged at 10 mA, which will fully discharge in three hours and is labeled as C/3. Similarly, the same 30 mAh battery discharged at a rate of 6 mA is referred to as being discharged at a C/5 rate.

Constant current discharge energy is calculated from the area under a voltage versus time discharge curve using the trapezoid method. Because the experiment was calculated based on mass of EMD, the units are reported as (J/g of EMD).

### Evaluation Based on Mass of EMD

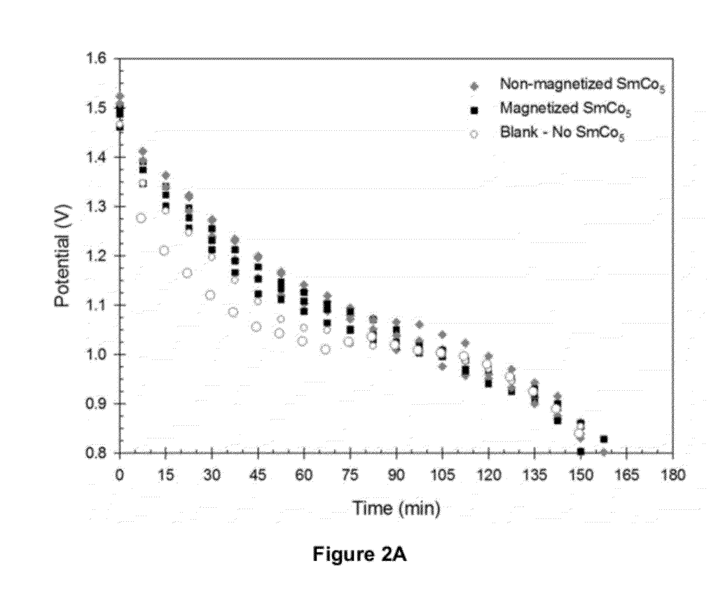

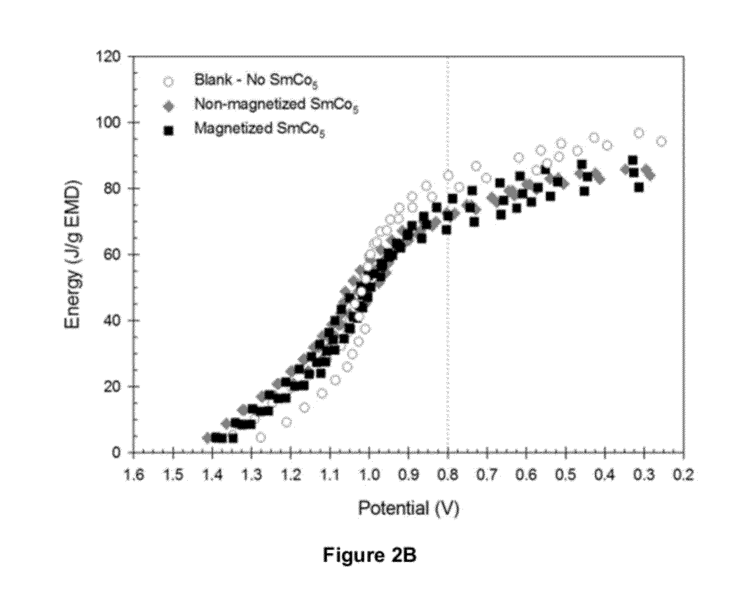

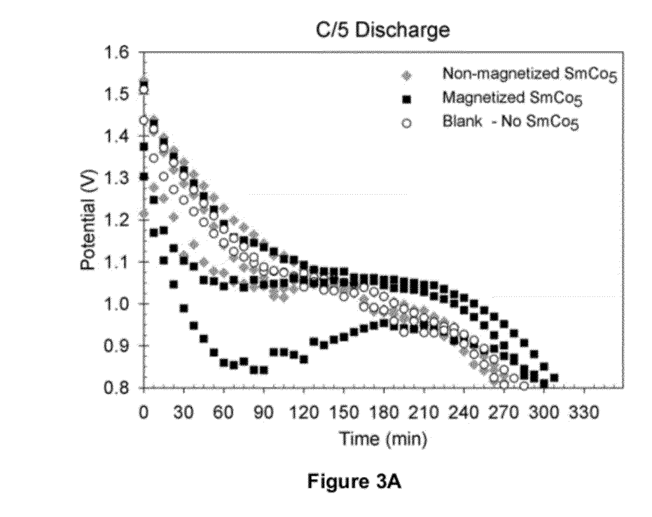

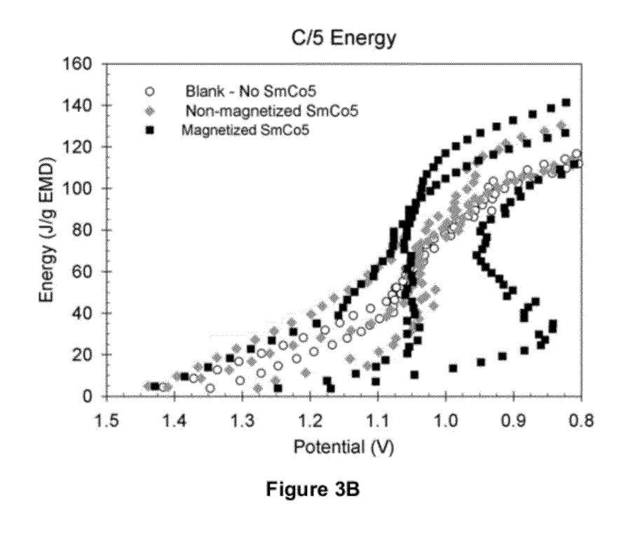

Batteries were discharged using two different discharge rates, C/3 and C/5, which were calculated to discharge the theoretical capacity of the battery within three and five hours, respectively. The notation C/n means that the theoretical capacity “C” of the battery based on mass of EMD will be discharge in n hours. C/n sets the constant current demanded of the EMD mass. In practice, real batteries will tend to discharge faster than n hours because of losses and inefficiencies in the battery. Time to a given voltage and energy are reported for batteries without SmCo₅ (“blank batteries”) and for batteries with SmCo₅ (“SmCo₅ batteries”), either magnetized or non-magnetized. Each battery was discharged under constant current conditions of C/3 and C/5. Representative discharge plots are set forth in FIGS. 2 and 3. Only data pertaining to C/5 discharges includes magnetized blanks. A battery was deemed unusable if the discharge voltage fell below 1.2 V within 10 minutes.

Energy versus potential data provided insight into the efficiency of a battery by comparing discharged energy at a given voltage, because batteries with greater efficiency are capable of outputting more energy. Values were calculated by numerically integrating the area under a voltage versus time curve using MS Excel. FIGS. 2A and 2B illustrate the efficiency of a battery at a given voltage with more energy representing a more efficient battery.

### C/3 Data

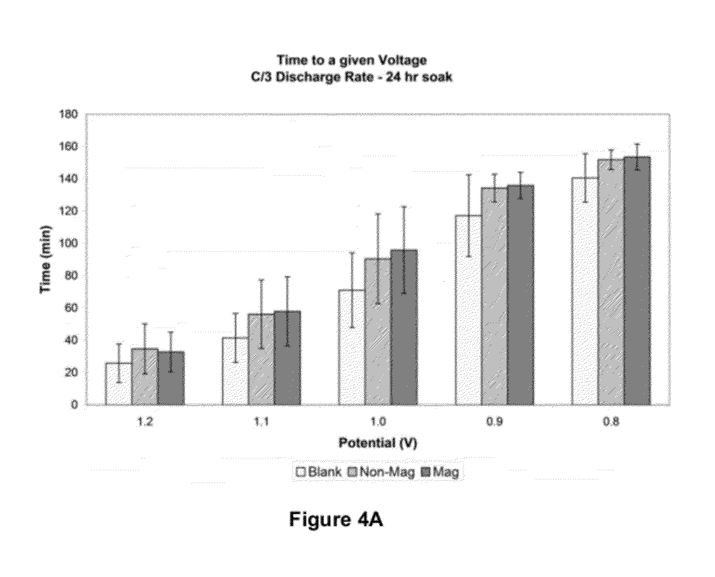

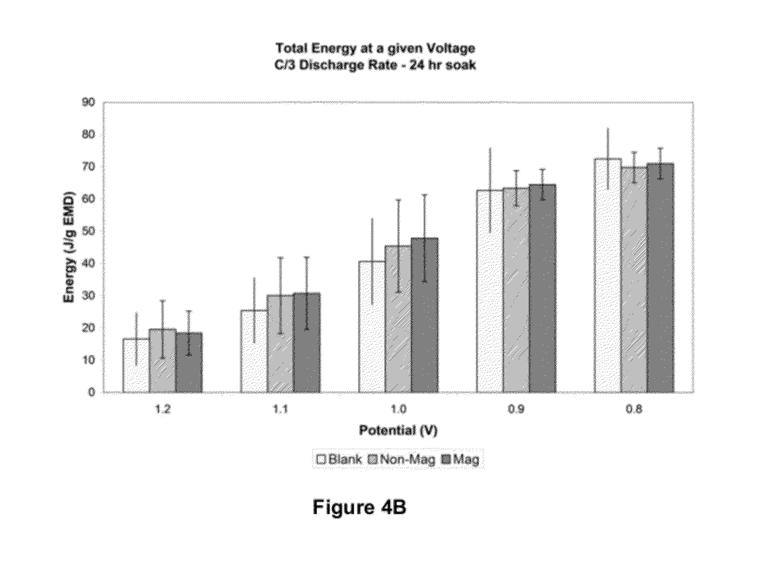

The data in FIG. 2A was collected during a constant current discharge experiment with voltage measured as a function of time. All data were collected on the same day and with the individual cathodes formed from the same corresponding batch mixture for the day. FIG. 2B is the energy versus potential calculated by integrating the area under the voltage versus time curve. These figures are included as representative data for experimental measurements and post-experiment evaluation. FIG. 4A illustrates average discharge times versus voltage, and FIG. 4B illustrates average total energies versus voltage at a C/3 discharge rate.

### C/5 Data

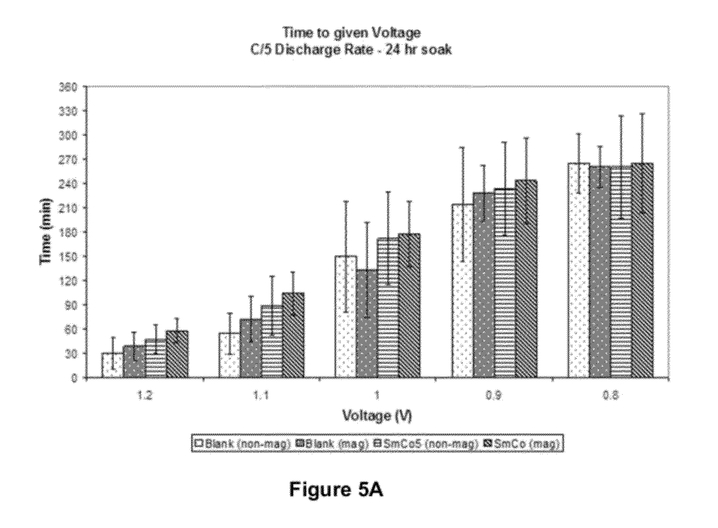

The data in FIG. 3A was collected during a constant current discharge experiment with voltage measured as a function of time for discharge rate C/5. All data were collected on the same day and with the individual cathodes formed from the same corresponding batch mixture for the day. FIG. 3B is the energy versus potential calculated by integrating the area under the voltage versus time curve. These figures are included as representative data for experimental measurements and post-experiment evaluation. FIG. 5A illustrates average discharge times versus voltage, and FIG. 5B illustrates average total energies versus voltage at a C/5 discharge rate.

Data Analysis and Summary with Statistics

Data were summarized from the voltage versus time discharge curves and the energy versus voltage curves. The only sieve on the data was that any voltage decay curve that fell below 1.0 V before ten minutes was excluded from the analysis as a poor battery. The fraction of excluded data sets were approximately 5% and were uniformly distributed across all classes of batteries.

### Parameters to Evaluate Effectiveness of Modification

Evaluations were based on the discharge curves of voltage with time and the curve for energy at a given voltage. Voltages examined in detail were 1.2, 1.1, 1.0, 0.9, and 0.8 V. Experiments were undertaken at C/5 and C/3 where the EMD cathode mixtures were formed and allowed to rest for 24 hours before being pressed into cathode pellets and placed in the battery clam shell with the anode and separator and then tested. Compositions of the blanks were 68% by weight EMD and composition of the SmCo₅ cathodes were 58% by weight EMD+10% by weight SmCo₅. The remaining 32% weight was composed of fixed amounts of binder, KOH electrolyte, and carbon conductor. Here, the values are reported per grams of EMD.

Time to a given voltage and energy are reported for batteries without SmCo₅ (“blank batteries”) and for batteries with SmCo₅ (“SmCo₅ batteries”), either magnetized or non-magnetized. Only data pertaining to C/5 discharges includes magnetized blanks.

### Time to a Given Voltage

Time to a given voltage is a measure of battery power and of capacity. From the voltage decay curves, the time was measured at each of five voltages (FIGS. 3 and 4). The number of samples in each class of samples is reported. The average time for each class of samples is shown in the Tables 1 and 2. The standard deviations for each average are also shown. Data are shown for C/5 and C/3 rates. The C/5 data includes data for magnetized blanks. These data are extracted from the discharge curves such as those of FIGS. 3 and 4.

Data for C/5 regimes are summarized in Table 1:

TABLE 1
Time (minutes) to a given voltage in a C/5 regime for blanks,
blanks subjected to magnetization by means of an electromagnet (“blank
e-mag”), SmCo₅ not subjected to magnetization (“SmCo₅ non-mag) and
batteries with SmCo₅ subjected to magnetization by means of an NdFeB
magnet (“SmCo₅ mag”).

| | | | Average Time to Given Voltage (min) | | | | | |
|---|---|---|---|---|---|---|---|---|
| | | n samples | 1.2 V | st dev | 1.1 V | st dev | 1.0 V | st dev |
| blank | non- | 24 | 30.2 | 19.0 | 54.8 | 25.4 | 150 | 69 |
| | mag | | | | | | | |
| blank | e- | 9 | 38.8 | 17.3 | 72.4 | 27.5 | 133 | 59 |
| | mag | | | | | | | |
| SmCo₅ | non- | 31 | 47.2 | 17.5 | 88.9 | 36.0 | 172 | 57 |
| | mag | | | | | | | |
| SmCo₅ | Mag | 11 | 58.0 | 14.8 | 104 | 27 | 178 | 40 |

| | | | Average Time to Given Voltage (min) | | | |
|---|---|---|---|---|---|---|
| | | n samples | 0.9 V | st dev | 0.8 V | st dev |
| blank | non- | 24 | 214 | 70 | 265 | 37 |
| | mag | | | | | |
| blank | e- | 9 | 228 | 34 | 260 | 25 |
| | mag | | | | | |
| SmCo₅ | non- | 31 | 233 | 58 | 260 | 63 |
| | mag | | | | | |
| SmCo₅ | Mag | 11 | 243 | 52 | 265 | 61 |

Averages are in bold. The corresponding standard deviations (st dev) are also reported.

The data reported in Table 1 show that the average time at a given voltage increases as follows: blank, non-mag<blank e-mag<SmCo₅ non-mag<SmCo₅ mag for all voltages above 0.8 V. All batteries were similarly discharged at 0.8 V, independent of composition and magnetization. Overall, relative standard deviations appeared to be large, but were smaller for blank mag and SmCo₅ mag, i.e. smaller for magnetized than non-magnetized cathodes, consistent with a reduction in entropy during magnetization.

Data for C/3 regimes are summarized in Table 2:

TABLE 2
Time (minutes) to a given voltage in a C/3 regime
for blanks, SmCo₅ non-mag) and SmCo₅ mag.

| | | | Average Time to Given Voltage (min) | | | | | |
|---|---|---|---|---|---|---|---|---|
| | | n samples | 1.2 V | st dev | 1.1 V | st dev | 1.0 V | st dev |
| Blank | non- | 9 | 25.8 | 11.9 | 41.5 | 15.1 | 71 | 23 |
| | mag | | | | | | | |
| Blank | e- | 0 | 0.0 | 0.0 | 0.0 | 0.0 | 0 | 0 |
| | mag | | | | | | | |
| SmCo₅ | non- | 17 | 34.8 | 15.4 | 56.2 | 21.2 | 91 | 28 |
| | mag | | | | | | | |
| SmCo₅ | mag | 17 | 32.8 | 12.3 | 58 | 21 | 96 | 27 |

| | | | Average Time to Given Voltage (min) | | | |
|---|---|---|---|---|---|---|
| | | n samples | 0.9 V | st dev | 0.8 V | st dev |
| Blank | non- | 9 | 117 | 25 | 141 | 15 |
| | mag | | | | | |
| Blank | e- | 0 | 0 | 0 | 0 | 0 |
| | mag | | | | | |
| SmCo₅ | non- | 17 | 134 | 9 | 152 | 6 |
| | mag | | | | | |
| SmCo₅ | mag | 17 | 136 | 8 | 154 | 8 |

Averages are in bold. The corresponding standard deviations (st dev) are also reported.

The data reported in Table 2 show that the average time at a given voltage increases as follows: blank, non-mag<SmCo₅ non-mag˜SmCo₅ mag for all voltages above 0.8 V. All batteries were similarly discharge at 0.8 V, independent of composition and magnetization. Relative standard deviations appear to exhibit patterns that are less clearly demarcated than for the slower C/5 discharge rate.

Power Considerations. Means of calculating the power at a given time or voltage are described below. Data are presented for C/5 and C/3 regimes in Tables 3 and 4, respectively, where results for blanks, SmCo₅ non-magnetized, and SmCo₅ magnetized are shown. Power readings are tabulated for 1.2, 1.1, 1.0, 0.9, and 0.8 Volts for C/5 and C/3 data.

Results for C/5 regimes are summarized in Table 3:

TABLE 3
Average power at several voltages for C/5 regimes for batteries
comprising blank or SmCo₅ cathodes, either magnetized
or non-magnetized.

| | |
|---|---|
| Blank | SmCo₅ |

Average Power (W/g EMD) at 1.2 V
for C/5

| | | |
|---|---|---|
| non- | 1.86 | 2.91 |
| mag | | |
| mag | 2.39 | 3.58 |

Average Power (W/g EMD) at 1.1 V
for C/5

| | | |
|---|---|---|
| non- | 3.10 | 5.02 |
| mag | | |
| mag | 4.09 | 5.89 |

Average Power (W/g EMD) at 1.0 V
for C/5

| | | |
|---|---|---|
| non- | 7.69 | 8.84 |
| mag | | |
| mag | 6.83 | 9.14 |

Average Power (W/g EMD) at 0.9 V
for C/5

| | | |
|---|---|---|
| non- | 9.91 | 10.79 |
| mag | | |
| mag | 10.53 | 11.25 |

Average Power (W/g EMD) at 0.8 V
for C/5

| | | |
|---|---|---|
| non- | 10.88 | 10.70 |
| mag | | |
| mag | 10.70 | 10.88 |

The data of Table 3 show that, for both blank and SmCo₅ batteries, magnetized cathodes generate higher power than the corresponding non-magnetized cathodes. SmCo₅ batteries generate higher power than blanks. Through 0.9 V, the pattern in power is blank, non-mag<blank mag<SmCo₅ non-mag<SmCo₅ mag. The effects of SmCo₅ and magnetization on power are more apparent at higher voltages. At 0.8 V, there appears to be no difference in the four classes of batteries. As these data are derived from the time to a given voltage, the relative errors are the same.

Results for C/3 regimes are summarized in Table 4:

TABLE 4
Average power at several voltages for C/3 regimes for batteries
comprising blank or SmCo₅ cathodes, either magnetized
or non-magnetized.

| | |
|---|---|
| Blank | SmCo₅ |

Average Power (W/g EMD) at 1.2 V for
C/3

| | | |
|---|---|---|
| non- | 2.65 | 3.57 |
| mag | | |
| mag | | 3.37 |

Average Power (W/g EMD) at 1.1 V for
C/3

| | | |
|---|---|---|
| non- | 3.91 | 5.29 |
| mag | | |
| mag | | 5.46 |

Average Power (W/g EMD) at 1.0 V for
C/3

| | | |
|---|---|---|
| non- | 6.08 | 7.75 |
| mag | | |
| mag | | 8.21 |

Average Power (W/g EMD) at 0.9 V for
C/3

| | | |
|---|---|---|
| non- | 9.03 | 10.35 |
| mag | | |
| mag | | 11.48 |

Average Power (W/g EMD) at 0.8 V for
C/3

| | | |
|---|---|---|
| non- | 9.63 | 10.41 |
| mag | | |
| mag | | 10.52 |

The data of Table 4 show that the SmCo₅ batteries generate higher power than blanks. Through 0.9 V, the pattern in power is blank non-mag<SmCo₅ non-mag˜SmCo₅ mag. The effects of SmCo₅ and magnetization are more apparent at higher voltages. As these data are derived from the time to a given voltage, the relative errors will be the same.

Details of Power Calculations. Time to a given voltage is a measure of rate, and therefore of power. Battery voltage at a fixed C/n decays with time. The longer a battery remains at a given voltage before decaying, the higher the rate and the higher the power, P(t). Power is defined as:

$$\begin{matrix}P ( t ) = i ( t ) V ( t ) \\ = {i}_{constant} V ( t ) for constant C / n\end{matrix} \qquad \begin{matrix} ( 9 ) \\ ( 10 )\end{matrix}$$

The constant current i_{constant} is in amps per gram of EMD and is established by C/n. Thus, the discharge curves of voltage (V(t)) with time are a measure of power for a given C/n. Usually, power is expected to be lower at lower n because a higher C/n demands a higher current that faces higher kinetic limitations.

Conversion of discharge curves to power curves is expressed as follows. One gram of MnO₂, the electroactive component in EMD, is equivalent to 0.011503, moles.

$$\frac{1.000 g}{MW {MnO}_{2}} = \frac{1.0000 g}{86.937 g \text{/} mol} = 0.01150 mol \qquad ( 11 )$$

From Faraday's Law, complete conversion of 0.01150 moles from MnO₂ to Mn³⁺, the one electron transfer is:

$$\begin{matrix}Q ( C / g {MnO}_{2} ) = nF \times \frac{mol {MnO}_{2}}{1.0000 g {MnO}_{2}} & ( 12 ) \\ = 1 \times \frac{96485 C}{mol} \times \frac{0.01150 mol}{1.0000 g {MnO}_{2}} & ( 13 ) \\ = \frac{1109.827 C}{1.0000 g {MnO}_{2}} = \frac{1109.827 As}{g {MnO}_{2}} & ( 14 ) \\ = \frac{1109.827 As}{g {MnO}_{2}} \times \frac{1000 mA}{A} \times \frac{hr}{3600 s} & ( 15 ) \\ = \frac{308.385 mA hr}{g {MnO}_{2}} & ( 16 )\end{matrix}$$

The same lot of EMD was used in all experiments and this was estimated to be of around 90% purity of MnO₂ by mass.

$$\frac{0.9 g {MnO}_{2}}{1.0 g EMD} \times \frac{308.385 mA hr}{g {MnO}_{2}} = \frac{256.9 mA hr}{g EMD} \qquad ( 17 )$$

For a given C/n and n hrs, this defines the constant current, i_{constant}, needed to discharge 1 g of EMD at a given C/n, for a one-electron process and 90% purity for EMD.

$${i}_{constant} = \frac{256.9 mA}{n g EMD} \qquad ( 18 )$$

Thus, from equation 10, the voltage discharge curves are converted to power curves. For i_{constant} in mA and V(t) in volts, the power is in mW or mJ/s. For C/5 and C/3,

$$\begin{matrix}{i}_{constant} ( C / 5 ) = \frac{51.38 mA}{g EMD} & ( 19 ) \\ {i}_{constant} ( C / 3 ) = \frac{85.63 mA}{g EMD} & ( 20 )\end{matrix}$$

Capacity. Capacity per gram of EMD at a given voltage can be defined in two ways: fraction of theoretical capacity, and capacity in mA hr/g EMD. For a given C/n, the fraction ratio of the time to a given voltage to n yields the fraction of theoretical capacity at the given voltage.

Fraction of theoretical capacity. Results for C/5 regimes are summarized in Table 5:

TABLE 5
Fraction of theoretical capacity for C/5 for four classes of batteries.
Average Fractional Capacity at Given Voltages for C/5

| | | 1.2 V | 1.1 V | 1.0 V | 0.9 V | 0.8 V |
|---|---|---|---|---|---|---|
| blank | non-mag | 0.10 | 0.18 | 0.50 | 0.71 | 0.88 |
| blank | e-mag | 0.13 | 0.24 | 0.44 | 0.76 | 0.87 |
| SmCo5 | non-mag | 0.16 | 0.30 | 0.57 | 0.78 | 0.87 |
| SmCo5 | mag | 0.19 | 0.35 | 0.59 | 0.81 | 0.88 |

For C/5, the data reported in Table 5 indicate a trend where fractional capacity increases as voltage decreases. All four classes of batteries achieved similar capacity of 87 to 88% at 0.8 V, a value approaching theoretical capacity. As 0.8 V is approached, the batteries appear to be anode limited and so the battery capacities do not assess the impacts of magnetic modifications. Fractional capacities for 0.9 V and higher voltages are ordered as: blank non-mag<blank mag<SmCo₅ non-mag<SmCo₅ mag. At these higher voltages, the batteries are not anode limited and the impact of magnetic modification is assessed.

Results for C/3 regimes are summarized in Table 6:

TABLE 6
Fraction of theoretical capacity for C/3 for four classes of batteries.
Average Fractional Capacity at Given Voltages for C/3

| | | 1.2 V | 1.1 V | 1.0 V | 0.9 V | 0.8 V |
|---|---|---|---|---|---|---|
| blank | non-mag | 0.14 | 0.23 | 0.39 | 0.65 | 0.78 |
| SmCo5 | non-mag | 0.19 | 0.31 | 0.50 | 0.75 | 0.84 |
| SmCo5 | mag | 0.18 | 0.32 | 0.53 | 0.76 | 0.85 |

For C/3, the data reported in Table 6 indicate a trend where fractional capacity increases as voltage decreases. The fractional capacity for the SmCo₅ batteries is comparable and higher than for the blanks. Both SmCo₅ batteries achieve similar capacities of 84 and 85% at 0.8 V. As above, approaching 0.8 V, the batteries become anode limited. Without being bound to any particular theory, the anode limitation is not based in stoichiometry of available zinc but in kinetic limits of the anode. These capacities approach the theoretical capacity limit and are slightly higher than the capacity of the blank at 0.8V. At higher voltages, the impact of SmCo₅ is apparent as the capacity is higher than the blanks. Without being bound to any particular theory, this appears to show better access to electroactive material in the SmCo₅ batteries than the blanks. The fractional capacities are ordered as: blank non-mag<SmCo₅ non-mag˜SmCo₅ mag.

Capacity in mA hr/g EMD. The maximum theoretical capacity for the first electron reduction (MnO₂→Mn³⁺) is 256.9 mA hr/g EMD. From the product of the fractional capacity and 256.9 mA hr/g EMD, the capacity in mA hr/g EMD is found. The maximum theoretical capacity used here is 256.9 mA hr/g EMD for the first electron reduction as MnO₂ is reduced to Mn³⁺.

Results for C/5 regimes are summarized in Table 7:

TABLE 7
Capacity (mA hr/g EMD) for C/5 regimes for four classes of batteries.
Average Capacity (mA hr/g EMD) at Given Voltages for C/5

| | | 1.2 V | 1.1 V | 1.0 V | 0.9 V | 0.8 V |
|---|---|---|---|---|---|---|
| blank | non-mag | 25.8 | 46.9 | 128.2 | 183.5 | 226.7 |
| blank | e-mag | 33.2 | 62.0 | 113.8 | 195.1 | 222.8 |
| SmCo5 | non-mag | 40.4 | 76.1 | 147.3 | 199.8 | 222.8 |
| SmCo5 | mag | 49.7 | 89.2 | 152.3 | 208.4 | 226.7 |

Results for C/3 regimes are summarized in Table 8:

TABLE 8
Capacity (mA hr/g EMD) for C/3 regimes for three classes of batteries.
Average Capacity (mA hr/g EMD) at Given Voltages for C/3

| | | 1.2 V | 1.1 V | 1.0 V | 0.9 V | 0.8 V |
|---|---|---|---|---|---|---|
| blank | non-mag | 36.9 | 59.2 | 101.4 | 167.3 | 200.7 |
| SmCo5 | non-mag | 49.6 | 80.2 | 129.2 | 191.7 | 216.9 |
| SmCo5 | mag | 46.8 | 82.7 | 136.8 | 194.0 | 219.2 |

As illustrated in Tables 7 and 8, for both C/5 and C/3 regimes patterns the average capacities directly mapped those of the fractional capacities. Under the slower C/5 discharge regime, more of the battery capacity was harvested at 0.8 V. Capacities at higher voltages tended to be higher for C/3 regimes and transitioned to lower capacities at lower voltages. For C/5 regimes, the capacities of the magnetized cells remained higher than analogous non-magnetized cells for voltages greater than 0.9 V. Without being bound to any particular theory, this likely reflected the more severe kinetic limitations associated with higher discharge rates.

### Energy at a Given Voltage

Energy is derived by integration of the discharge curves, V(t) with time. Energy (J/g EMD) is found as:

$$\begin{matrix}Energy ( t ) = {\int }_{0}^{t} current ( τ ) V ( τ ) d τ & ( 21 ) \\ = {i}_{constant} {\int }_{0}^{t} V ( τ ) d τ for constant current & ( 22 )\end{matrix}$$

where

$${i}_{constant } = \frac{256.9 mA}{n g EMD} for C / n .$$

Results for C/5 regimes are reported in Table 9 and illustrated in FIG. 3.

TABLE 9
Average energy with standard deviations
at selected voltages for C/5 regimes.

| | | n | Average Energy (J/g of EMD) at Given Voltage | | | | | |
|---|---|---|---|---|---|---|---|---|
| | | sam- | | st | | st | | st |
| | | ples | 1.2 V | dev | 1.1 V | dev | 1.0 V | dev |
| blank | non- | 24 | 16.3 | 10.7 | 28.1 | 14.0 | 69.3 | 31.1 |
| | mag | | | | | | | |
| blank | e- | 9 | 20.7 | 9.2 | 36.5 | 13.5 | 62.6 | 25.4 |
| | mag | | | | | | | |
| SmCo₅ | non- | 31 | 25.5 | 9.8 | 45.4 | 18.9 | 81.5 | 27.2 |
| | mag | | | | | | | |
| SmCo₅ | mag | 11 | 32.2 | 8.6 | 54.4 | 14.0 | 86.9 | 18.5 |

| | | n | Average Energy (J/g of EMD) at Given Voltage | | | |
|---|---|---|---|---|---|---|
| | | sam- | | st | | st |
| | | ples | 0.9 V | dev | 0.8 V | dev |
| blank | non- | 24 | 95.2 | 31.6 | 114 | 17 |
| | mag | | | | | |
| blank | e- | 9 | 101 | 14 | 113 | 10 |
| | mag | | | | | |
| SmCo₅ | non- | 31 | 106 | 26 | 115 | 28 |
| | mag | | | | | |
| SmCo₅ | mag | 11 | 113 | 19 | 120 | 22 |

As illustrated in Table 9, for C/5 regimes, average energies at a given voltage are ordered as: blank non-mag<blank mag<SmCo₅ non-mag<SmCo₅ mag for all voltages. Relative standard deviations are less for blanks and for SmCo₅ when magnetized than non-magnetized, consistent with a reduction in entropy under magnetization.

Results for C/3 regimes are reported in Table 10 and illustrated in FIG. 2:

TABLE 10
Average energy with standard deviations
at selected voltages for C/3 regimes.

| | | n | Average Energy (J/g of EMD) at Given Voltage | | | | | |
|---|---|---|---|---|---|---|---|---|
| | | sam- | | st | | st | | st |
| | | ples | 1.2 V | dev | 1.1 V | dev | 1.0 V | dev |
| Blank | non- | 9 | 16.6 | 8.2 | 25.4 | 10.1 | 40.6 | 13.3 |
| | mag | | | | | | | |
| SmCo₅ | non- | 17 | 19.6 | 8.9 | 30.0 | 11.7 | 45.4 | 14.3 |
| | mag | | | | | | | |
| SmCo₅ | mag | 17 | 18.4 | 6.8 | 30.7 | 11.2 | 47.9 | 13.4 |

| | | n | Average Energy (J/g of EMD) at Given Voltage | | | |
|---|---|---|---|---|---|---|
| | | sam- | | st | | st |
| | | ples | 0.9 V | dev | 0.8 V | dev |
| Blank | non- | 9 | 62.7 | 13.1 | 72 | 9 |
| | mag | | | | | |
| SmCo₅ | non- | 17 | 63 | 5 | 70 | 5 |
| | mag | | | | | |
| SmCo₅ | mag | 17 | 64 | 5 | 71 | 5 |

As illustrated in Table 10, for C/3 regimes, average energies at a given voltage are ordered as: blank non-mag<SmCo₅ non-mag SmCo₅, mag for all voltages >0.9 V. Relative standard deviations appear to be marginally less for SmCo₅ than the blanks.

### Ratios of Parameters to Evaluate Effectiveness of Modification and Their Statistical Significance to Evaluate Effectiveness of Modification

The impact of modification was evaluated by examining ratios of the parameters outlined above. Several parameters were evaluated to assess the effectiveness of magnetic modification. These were expressed as ratios of two observables, where multiple replicates for each set of conditions allowed means (xᵢ), standard deviations (st devᵢ), relative error (rel errorᵢ), and number of samples (count or nᵢ) for each data set. Ratios were determined from the values of xᵢ, and the statistical significance was assessed through propagation of errors and t-tests under the null hypothesis that the ratio was not statistically significant (i.e., for ratio x₁/x₂ the null hypothesis is x₁=x₂). The t-tests required that several other parameters be calculated; this includes t-tests (t_{calc}), pooled standard deviations (s_{pooled}), and F-tests to determine if the standard deviations are the same (F_{calc}). Details of the statistical processing are outlined below.

Because batteries are complicated systems and all the batteries of the experiment were made individually and by hand, the relative standard deviations are relatively high. This determined the statistical assessments that were used and allowed. Confidence levels of 95% and higher are most typically considered persuasive, but the uncertainties are sufficiently high in some cases that this level of confidence cannot be ascribed. When the null hypothesis is used to evaluate data, the level of confidence is reported. With more batteries and more automated processing, the confidence levels would likely be higher. In some cases, especially at higher voltages, the confidence levels are higher.

The patterns in the above data are reflected in the time to a given voltage, which also maps capacity and power as above, and energy with voltage. Ratios for time to a give voltage and energy with voltage are evaluated. In the tables, the first two columns describe the system in the numerator of the ratio; the third and fourth column describe the denominator. For example, blank e-mag blank non-mag describes the ratio of parameters for the magnetized blank relative to the non-magnetized blank; a ratio greater than 1 suggests the magnetization impacts the performance relative to the nonmagnetized blank at a level of confidence reported in the table.

### Time to a Given Voltage

Results for C/5 regimes are summarized in Table 11:

TABLE 11
Comparison of different electrode performance represented as a
ratio of times to a given voltage for five potentials at C/5.

| | | | | Ratio of Time to Given Voltage (min) | | | | | |
|---|---|---|---|---|---|---|---|---|---|
| | | | | (Capacity and Power) | | | | | |
| | | | | | conf | | conf | | conf |
| Type | Modification Vs | Type | Modification | 1.2 V | level | 1.1 V | level | 1.0 V | level |
| Blank | e-mag | Blank | non-mag | 1.29 | 75.5 | 1.32 | 90.7 | 0.89 | 47.8 |
| SmCo₅ | non-mag | Blank | non-mag | 1.57 | 99.9 | 1.62 | 100.0 | 1.15 | 80.5 |
| SmCo₅ | mag | Blank | non-mag | 1.92 | 100.0 | 1.90 | 100.0 | 1.19 | 78.4 |
| SmCo₅ | mag | SmCo₅ | non-mag | 1.23 | 92.4 | 1.17 | 79.2 | 1.03 | 24.5 |
| SmCo₅ | non-mag | Blank | e-mag | 1.22 | 79.2 | 1.23 | 78.7 | 1.29 | 91.8 |
| SmCo₅ | mag | Blank | e-mag | 1.50 | 98.5 | 1.44 | 98.3 | 1.34 | 94.2 |

| | | | | Ratio of Time to Given Voltage (min) | | | |
|---|---|---|---|---|---|---|---|
| | | | | (Capacity and Power) | | | |
| | | | | | conf | | conf |
| Type | Modification Vs | Type | Modification | 0.9 V | level | 0.8 V | level) |
| Blank | e-mag | Blank | non-mag | 1.06 | 41.3 | 0.98 | 26.3 |
| SmCo₅ | non-mag | Blank | non-mag | 1.09 | 72.5 | 0.98 | 24.4 |
| SmCo₅ | mag | Blank | non-mag | 1.14 | 76.9 | 1.00 | 0.2 |
| SmCo₅ | mag | SmCo₅ | non-mag | 1.04 | 38.6 | 1.02 | 16.4 |
| SmCo₅ | non-mag | Blank | e-mag | 1.02 | 21.2 | 1.00 | 0.0 |
| SmCo₅ | mag | Blank | e-mag | 1.07 | 54.6 | 1.02 | 16.3 |

The ratios are in boldface; the level of confidence is also shown.

As seen in Table 11, for C/5 regimes the ratios are greater than 1 for all but one case for voltages greater than 0.8 V. This uniformity of pattern is consistent with magnetization exerting a useful effect. The addition of SmCo₅ also exerts a useful effect, where magnetized is better than non-magnetized SmCo₅. Without being bound by any specific theory, there is the possibility of a degree of residual magnetization in the SmCo₅ as received from its manufacturer; the as received SmCo₅ could have some residual magnetization which exceeds that of demagnetized materials but is less than that of SmCo₅ intentionally magnetized by means of an external magnet.

Table 11 provides levels of confidence for each ratio. Considering SmCo₅ batteries as compared to the non-magnetized blank, as reported in rows 2 and 3 of Table 11, it appears that, for SmCo₅ batteries as compared to non-magnetized blanks, data at higher voltages provides high confidence that the SmCo₅ batteries perform better than the blank. Moreover, the largest effects are found in the ratios for the magnetized SmCo₅ as compared to the blank non-magnetized at 1.2 and 1.1 V, where the time to a given voltage is around 90% higher than for the non-magnetized blank. This is at a high degree of confidence.

For the non-magnetized SmCo₅ at 1.2 and 1.1 V as compared to the non-magnetized blank, the time to a given voltage is around 60% longer. This is at a high degree of confidence. Ratios and confidence level decrease as the battery discharges.

Considering magnetized SmCo₅ batteries as compared to non-magnetized SmCo₅ batteries, as reported in row 4 of Table 11, it appears that, at the higher voltages, the magnetized SmCo₅ provides statistically better results than the non-magnetized SmCo₅. At lower voltages, such effects are not apparent. Without being bound to any particular theory, this may be because at the lower voltages the batteries are Zn-limited, a problem that would be more prevalent in batteries that are characterized by an especially high efficiency, such as those having electrodes with SmCo₅.

Considering the behavior of the magnetized blank, as reported in row 1, 2, and 5 in Table 11, it can be seen that, at high voltages, the magnetized blank is arouhd 30% better than the nonmagnetized blank with a high degree of confidence. For voltages of 1.0 V and lower, the magnetized blank does not appear to improve or hinder performance as compared to the non-magnetized blank. A comparison of the non-magnetized SmCo₅ to the magnetized blank shows a better performance for the non-magnetized SmCo₅ than the magnetized blank at voltages higher than 0.9 V by about 20% with some degree of confidence. A comparison of magnetized SmCo₅ to magnetized blank shows better performance by 35 to 50% for voltages from 1.0 to 1.2 V, with high confidence. There appears to be little effect at the lower voltages.

Results for C/3 regimes are summarized in Table 12:

TABLE 12
Comparison of different electrode performances represented as
a ratio of times to a given voltage for five potentials at C/3.

| | | | | Ratio of Time to Given Voltage (min) | | | | | |
|---|---|---|---|---|---|---|---|---|---|
| | | | | (Capacity and Power) | | | | | |
| | | | | | conf | | conf | | conf |
| Type | Modification Vs | Type | Modification | 1.2 V | level | 1.1 V | level | 1.0 V | level |
| SmCo₅ | non-mag | blank | non-mag | 1.35 | 85.5 | 1.35 | 92.1 | 1.27 | 91.5 |
| SmCo₅ | mag | blank | non-mag | 1.27 | 82.4 | 1.40 | 94.8 | 1.35 | 97.3 |
| SmCo₅ | mag | SmCo₅ | non-mag | 0.94 | 31.2 | 1.03 | 19.2 | 1.06 | 42.9 |

| | | | | Ratio of Time to Given Voltage (min) | | | |
|---|---|---|---|---|---|---|---|
| | | | | (Capacity and Power) | | | |
| | | | | | conf | | conf |
| Type | Modification Vs | Type | Modification | 0.9 V | level | 0.8 V | level |
| SmCo₅ | non-mag | blank | non-mag | 1.15 | 98.3 | 1.08 | 98.9 |
| SmCo₅ | mag | blank | non-mag | 1.16 | 99.1 | 1.09 | 99.2 |
| SmCo₅ | mag | SmCo₅ | non-mag | 1.01 | 42.5 | 1.01 | 48.9 |

The ratios are in boldface; the level of confidence is also shown.

Considering SmCo₅ batteries as compared to the non-magnetized blank, as illustrated in rows 1 and 2 of Table 12, it can be seen that the ratios are greater than 1 in all instances. This uniformity of pattern is consistent with the addition of SmCo₅ having a useful effect. The confidence levels also support the utility of adding SmCo₅. The effects of adding SmCo₅ to the matrix are in the range of 25 to 40% for voltages higher than 0.9 V, with a strong degree of confidence.

Considering magnetized SmCo₅ batteries as compared non-magnetized SmCo₅ batteries, as illustrated in row 3 of Table 12, it can be seen that at C/3 regimes, there is no statistically significant difference in the responses for the magnetized and non-magnetized SmCo₅ batteries. At the higher voltages, the magnetized SmCo₅ is statistically better than the non-magnetized SmCo₅. At lower voltages, effects are not apparent. Without being bound to any particular theory, this may be because at the lower voltages the batteries are Zn-limited, a problem that would be more prevalent in batteries that are characterized by an especially high efficiency, such as those having electrodes with SmCo₅. There are no data for the magnetized blank at the C/3 regime.

### Energy at a Given Voltage

Trends in energy at a given voltage were found to usually track the trends in time to a given voltage. Results for C/5 regimes are summarized in Table 13.

TABLE 13
Comparison of different electrode performance represented as a
ratio of energy at a given voltage for five potentials at C/5.

| | | | | Ratio of Energy (J/g EMD) at a Given Voltage | | | | | |
|---|---|---|---|---|---|---|---|---|---|
| | | | | | conf | | conf | | conf |
| Type | Modification Vs | Type | Modification | 1.2 V | level | 1.1 V | level | 1.0 V | level |
| Blank | e-mag | Blank | non-mag | 1.27 | 71.1 | 1.30 | 86.9 | 0.90 | 43.6 |
| SmCo₅ | non-mag | Blank | non-mag | 1.57 | 99.8 | 1.62 | 100.0 | 1.18 | 87.2 |
| SmCo₅ | mag | Blank | non-mag | 1.97 | 100.0 | 1.94 | 100.0 | 1.25 | 90.7 |
| SmCo₅ | mag | SmCo₅ | non-mag | 1.26 | 94.6 | 1.20 | 84.5 | 1.07 | 45.3 |
| SmCo₅ | non-mag | Blank | e-mag | 1.24 | 81.0 | 1.24 | 80.5 | 1.30 | 93.0 |
| SmCo₅ | mag | Blank | e-mag | 1.56 | 99.0 | 1.49 | 99.1 | 1.39 | 97.6 |

| | | | | Ratio of Energy (J/g EMD) at a Given Voltage | | | |
|---|---|---|---|---|---|---|---|
| | | | | | conf | | conf |
| Type | Modification Vs | Type | Modification | 0.9 V | level | 0.8 V | level |
| Blank | e-mag | Blank | non-mag | 1.06 | 41.8 | 0.99 | 8.7 |
| SmCo₅ | non-mag | Blank | non-mag | 1.11 | 81.9 | 1.01 | 19.4 |
| SmCo₅ | mag | Blank | non-mag | 1.19 | 90.2 | 1.06 | 67.0 |
| SmCo₅ | mag | SmCo₅ | non-mag | 1.07 | 59.2 | 1.05 | 42.5 |
| SmCo₅ | non-mag | Blank | e-mag | 1.04 | 36.9 | 1.02 | 19.0 |
| SmCo₅ | mag | Blank | e-mag | 1.11 | 84.8 | 1.07 | 64.2 |

The ratios are in boldface; the level of confidence is also shown.

As illustrated in Table 13, for C/5 regimes, the ratios are greater than 1 for all but one case for voltages higher than 0.8 V. This uniformity of pattern is consistent with magnetization exerting a useful effect. The addition of SmCo₅ also has a useful effect, where magnetized is better than non-magnetized SmCo₅. Without being bound by any specific theory, there is the possibility of a degree of residual magnetization in the SmCo₅ as received from its manufacturer; the as received SmCo₅ could have some residual magnetization which exceeds that of demagnetized materials but is less than that of SmCo₅ intentionally magnetized by means of an external magnet.

Table 13 provides levels of confidence for each ratio. Considering data comparing SmCo₅ batteries compared to the non-magnetized blank, as set forth in rows 2 and 3 of Table 13, it can be seen that, for SmCo₅ batteries as compared to non-magnetized blanks, data collected at higher voltages provides high confidence that the SmCo₅ batteries perform better than the blank. The largest effects are found in the ratios for the magnetized SmCo₅, as compared to the blank non-magnetized at 1.2 and 1.1 V, where the time to a given voltage is around 95% higher than for the non-magnetized blank. This is at a high degree of confidence. For the non-magnetized SmCo₅ at 1.2 and 1.1 V, as compared to the non-magnetized blank, the time to a given voltage is about 60% longer. This is at a high degree of confidence. Ratios and confidence levels decrease as the battery discharges.

Considering magnetized SmCo₅ batteries as compared non-magnetized SmCo₅ batteries, as illustrated in row 4 of Table 13, it can be seen that at the higher voltages, the magnetized SmCo₅ is statistically better than the non-magnetized SmCo₅ by around 20%. At lower voltages, such effects are not apparent. Without being bound to any particular theory, this may be because at the lower voltages the batteries are Zn-limited, a problem that would be more prevalent in batteries that are especially efficient, such as those having electrodes with SmCo₅.

Considering the behavior of the magnetized blank, as illustrated in row 1, 2, and 5 of Table 13, at high voltages, the magnetized blank is around 30% better than the non-magnetized blank with a high degree of confidence. For voltages of 1.0 V and lower, the magnetized blank does not improve or hinder performance as compared to the nonmagnetized blank. A comparison of the non-magnetized SmCo₅ to the magnetized blank yields better performance for the non-magnetized SmCo₅ than the magnetized blank at voltages higher than 0.9 V by around 30% with some confidence. A comparison of magnetized SmCo₅ to magnetized blank yields better performance by 40 to 55% for voltages from 1.0 to 1.2 V with high confidence. There is little effect at the lower voltages.

Results for C/3 regimes are summarized in Table 14:

TABLE 14
Comparison of different electrode performance represented as a ratio
of energy at a given voltage for five potentials at C/3 regimes.

| | | | | Ratio of Energy (J/g EMD) at a Given Voltage | | | | | |
|---|---|---|---|---|---|---|---|---|---|
| | | | | | conf | | conf | | conf |
| Type | Modification Vs | Type | Modification | 1.2 V | level | 1.1 V | level | 1.0 V | level |
| SmCo₅ | non-mag | Blank | non-mag | 1.18 | 58.7 | 1.18 | 67.2 | 1.12 | 58.9 |
| SmCo₅ | mag | Blank | non-mag | 1.11 | 45.2 | 1.21 | 75.6 | 1.18 | 80.0 |
| SmCo₅ | mag | SmCo5 | non-mag | 0.94 | 32.2 | 1.02 | 14.2 | 1.05 | 39.1 |

| | | | | Ratio of Energy (J/g EMD) at a Given Voltage | | | |
|---|---|---|---|---|---|---|---|
| | | | | | conf | | conf |
| Type | Modification Vs | Type | Modification | 0.9 V | level | 0.8 V | level |
| SmCo₅ | non-mag | Blank | non-mag | 1.01 | 15.3 | 0.96 | 65.5 |
| SmCo₅ | mag | Blank | non-mag | 1.03 | 39.2 | 0.98 | 40.1 |
| SmCo₅ | mag | SmCo5 | non-mag | 1.02 | 47.1 | 1.02 | 53.1 |

The ratios are in boldface; the level of confidence is also shown.

For C/3 regimes, as seen in Table 14, the statistics for the energy at a given voltage are not strong and the propagation of errors yields relatively large uncertainties. However, considering SmCo₅ batteries as compared to the non-magnetized blank, as reported in rows 1 and 2 of Table 14, the ratios are greater than 1 for all cases. This uniformity of pattern is consistent with addition of SmCo₅ having a useful effect, and the effects of adding SmCo₅ to the matrix is around 20% for voltages higher than 0.9 V with some degree of confidence. Considering magnetized SmCo₅ batteries as compared non-magnetized SmCo₅ batteries, as reported in row 3 of Table 14, there appears to be no statistically significant difference in the responses for the magnetized and non-magnetized SmCo₅ batteries. Not data for the magnetized blank at C/3 regimes were acquired.

### Summary of Statistical Tests

Propagation of Error. The first statistical evaluation is propagation of relative error. For division and multiplication steps, the relative error is used such that for a ratio,

rel error=\sqrt{rel error₁²+rel error₂²} (23)

The rel error₁ is calculated from the corresponding standard deviation st devᵢ and mean xᵢ.

$$rel {error}_{i} = \frac{st dev}{{x}_{i}} \qquad ( 24 )$$

Overall, the relative errors of the data reported in Tables 1-14 are relatively large. This affects the ratios reported in the Tables, as the relative errors propagate to yield similarly large relative errors that in turn affect the significance of the results. To evaluate the significance of the ratios, t-tests were generated under the null hypothesis that the means used to calculate the ratios were not different. This is outlined below.

t-test. Statistical evaluation using the t-test is required because of the small data sets (n<40) utilized in each category. The t-test is a mathematical method to compare multiple, yet different, batch runs of the same experiment or process to determine whether or not the batches runs are similar and is reported as a confidence percentage. For comparison of means, the t-test is used. The equations below are taken from Harris, Quantitative Analysis, 7th edition.

$$\begin{matrix}{t}_{calc} = \frac{\vert {x}_{1} - {x}_{2} \vert}{{s}_{pooled}} \sqrt{\frac{{n}_{1} {n}_{2}}{{n}_{1} + {n}_{2}}} & ( 25 ) \\ {s}_{pooled} = \sqrt{\frac{{s}_{1}^{2} ( {n}_{1} - 1 ) + {s}_{2}^{2} ( {n}_{2} - 1 )}{{n}_{1} + {n}_{2} - 2}} & ( 26 )\end{matrix}$$

for n₁+n₂−2 degrees of freedom. For a given level of confidence t_{calc}>t_{table}, then the two means are considered to be different.

Comments on the F-test and Application of the t-test. The equations 25 and 26 assume the population standard deviations for the two data sets are the same. This is determined by the F-test, where

$${F}_{calc} = \frac{{s}_{1}^{2}}{{s}_{2}^{2}} \qquad ( 27 )$$

If F_{cal}>F_{table}, then the difference in standard deviations is significant. F_{table} is given in terms of the degrees of freedom for s₁ and s₂. The function call in Scientific Workplace is Flnv (0:95; 10; 10)=2: 9782 which is 95% confidence of F_{table} for each 10 degrees of freedom.

If the standard deviations are different, then the t-test equations are replaced with

$${t}_{calc} = \frac{\vert {x}_{1} - {x}_{2} \vert}{\sqrt{\frac{{s}_{1}^{2}}{{n}_{1}} + \frac{{s}_{2}^{2}}{{n}_{2}}}} \qquad ( 28 )$$

for

$$degrees of freedom = \frac{{( \frac{{s}_{1}^{2}}{{n}_{1}} + \frac{{s}_{2}^{2}}{{n}_{2}} )}^{2}}{\frac{{( \frac{{s}_{1}^{2}}{{n}_{1}} )}^{2}}{{n}_{1} + 1} + \frac{{( \frac{{s}_{2}^{2}}{{n}_{2}} )}^{2}}{{n}_{2} + 1}} - 2 \qquad ( 29 )$$

For the data collected at C/5 regimes and a 95% confidence level, 68% of the ratios yield an F_{cal}<F_{table}. At the 99% level, all but a few values at 0.8 V yield F_{calc}<F_{table}. Thus, all values of t_{calc} were determined using equations 25 and 26.

Further Observations on the Import of the Magnetized Blank in the C/5, Regimes Data

Unique to the C/5 data are some results that compare two blank electrodes, one magnetized and one not magnetized. The magnetized blank persistently exhibits performance superior to that of the non-magnetized blank. Without being bound to any particular theory, this is believed to be due to the magnetization of MnO₂, because all reported manganese oxygen species are known to be paramagnetic [6, 7].

The discovery that magnetizing a blank makes it perform better than an analogous but non-magnetized blank is an important result because the two blanks are chemically the same and likely structurally the same. Without being bound to any particular theory, it is believed that the observed effect can be ascribed to magnetization because the electrodes are otherwise the same, and there is no introduction of chemical mediators in such a system, as there is when adding materials such as SmCo₅. This strongly supports the idea that magnetization is leading to the improved performance, likely through enhanced electron transfer rates.

### Example 2

The recipe of the cathode mixtures of Example 1 was altered to provide a more stable and consistent battery discharge. The experiments, procedures, and collection of data were carried out in essentially the same way as described in Example 1. The system of Example 2 behaved as though it was anode limited, as evident of the behavior seen in the Voltage vs. Time curves below 1.1 V. Without being bound to any particular theory, it is believed that the data of Example 2 present a more accurate picture of the observed enhancement because the battery compositions are more stable, which in turn is likely due to the lower electrolyte and higher conductivity enhancer concentrations.

### Cathode Mixture Preparation

The reagents listed in the table below were mixed by mass to the following mass percentages. All reagents were in powder form and used as received. Powders were mixed first and rotated in a tumbler to ensure homogeneity. As detailed below, cathode mixtures with and without KOH electrolyte were prepared.

Cathode Mixture without Electrolyte:

| | | Magnetically |
|---|---|---|
| | Blank | modified |
| Reagent | (w/w %) | (w/w %) |
| MnO₂ | 80 | 75 |
| Graphite | 15 | 15 |
| PTFE | 5 | 5 |
| SmCo₅ | 0 | 5 |
| KOH, 9M | 0 | 0 |

Cathode Mixture with Electrolyte:

| | | Magnetically |
|---|---|---|
| | Blank | modified |
| Reagent | (w/w %) | (w/w %) |
| MnO₂ | 75 | 70 |
| Graphite | 15 | 15 |
| PTFE | 5 | 5 |
| SmCo₅ | 0 | 5 |
| KOH, 9M | 5 | 5 |

Once the powders were mixed, the electrolyte was blended in to generate the cathode mixture which was allowed to soak up to 48 hours. The cathode mixture was then transferred into a custom-made die, and 8 metric tons of pressure per cm² were applied with a hydraulic press for 60 seconds. The pressure was then gently released and immediately reapplied for 30 seconds, for a total pressing time of 90 seconds. The resulting pellets were then magnetized by setting cathode mixture pellets inside an NdFeB permanent ring magnet for 5 minutes.

### Non-Modified Cathode Preparation

The only difference between the blank and magnetically modified cathode mixtures was the exclusion of samarium cobalt, which was equally substituted with EMD in the blank. This increased the EMD w/w % to 80% and decreased the SmCo₅ w/w % to 0 w/w %. All other reagents remained the same as did the pressing procedure.

### Anode Preparation

Granulated zinc metal (battery grade, Umicore) and 9 M KOH (Fisher Scientific) electrolyte were the only reagents used in the anode. A volume of 200 μL of electrolyte was directly added to the zinc metal during the battery assembly process.

### Assembly and Testing Apparatus

A clam shell style battery canister (MTI Corporation) was used to house the two half-cells. The assembly, illustrated in FIG. 1, comprised a stainless steel apparatus insulated to maintain electrical separation of the anode and cathode. No additional current collector was used within the clamshell assembly. The zinc anode rested directly on the stainless steel clamshell. A PTFE ring was then placed over the anode to maintain electrical insulation. A cellulose based separator was cut from a piece of filter paper (Whatman #1, Whatman Ltd, UK) and wetted by saturating in KOH electrolyte to serve as the charge separator between the anode and cathode. The EMD cathode pellet was placed on top of the separator and then forced inside the insulating ring to achieve contact with the anode. The clam shell cathode was then secured into place to complete the battery. A PC-controlled battery analyzer (MTI Corporation) with independent channel capability measured voltage and current separately. Batteries were discharged at a constant rate based on individual theoretical maximum capacity, which is directly related to the amount of EMD within the cathode. To ensure the system was quantifying cathode effects only, battery capacities were controlled by designating the cathode (EMD specifically) as the limiting reagent and utilizing excess zinc in the anode.

### Evaluation Based on Mass of EMD

Batteries were discharged using two different discharge rates, C/3 and C/5, which discharged the theoretical capacity of the battery within three and five hours, respectively. Each battery's discharge rate was calculated individually because the cathode masses varied slightly. Although the demand current on the battery was different from one battery to the next, the discharge rate categorically belonged to either a C/3 or C/5 process. No sieve or data filtering was applied to the obtained data sets.

### Results

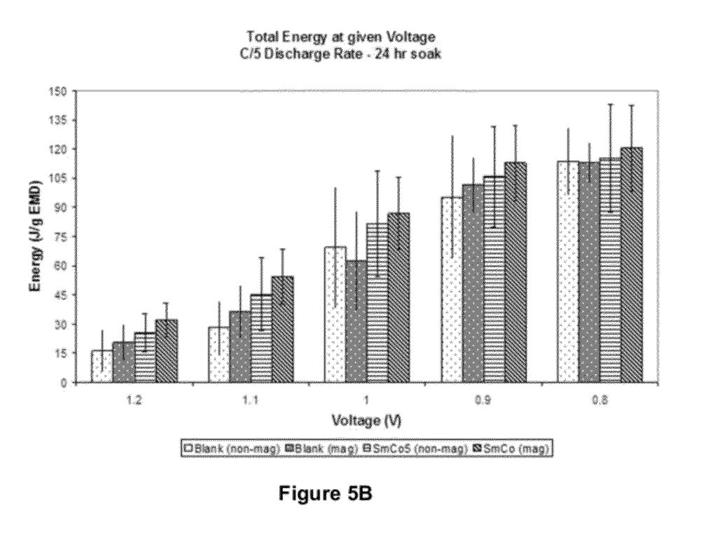

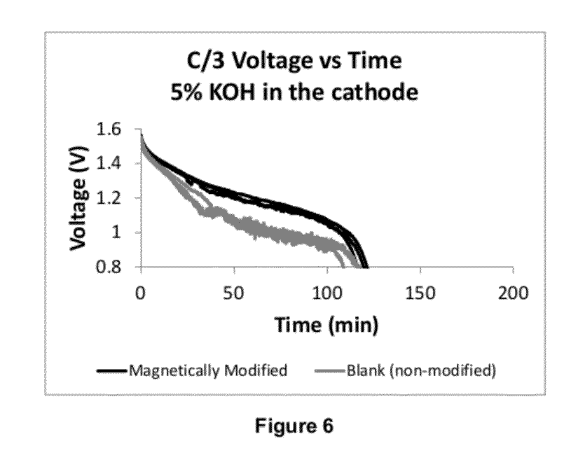

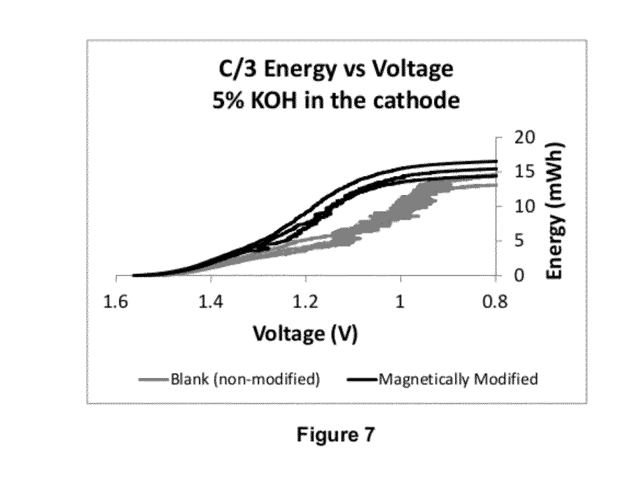

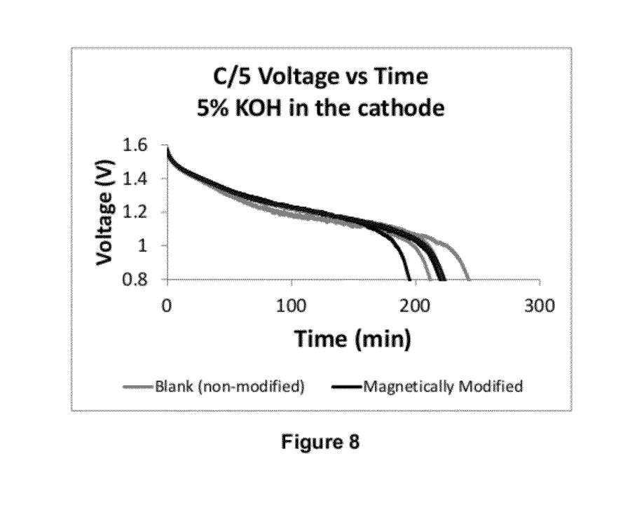

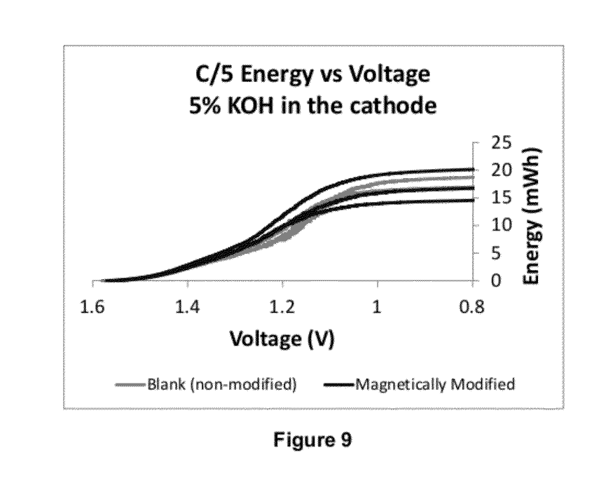

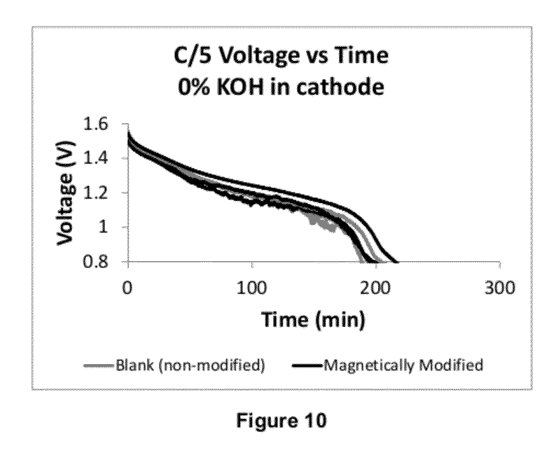

The graphs set forth FIGS. 6 and 7 are for batteries containing 5 w/w % KOH electrolyte in the cathode mixture with a discharge rate of C/3. The graphs of FIGS. 8 and 9 are for batteries containing 5 w/w % KOH electrolyte in the cathode mixture with a discharge rate a C/5. FIGS. 10 and 11 include graphs for batteries containing 0 w/w % KOH in the cathode mixture with a discharge rate of C/5.

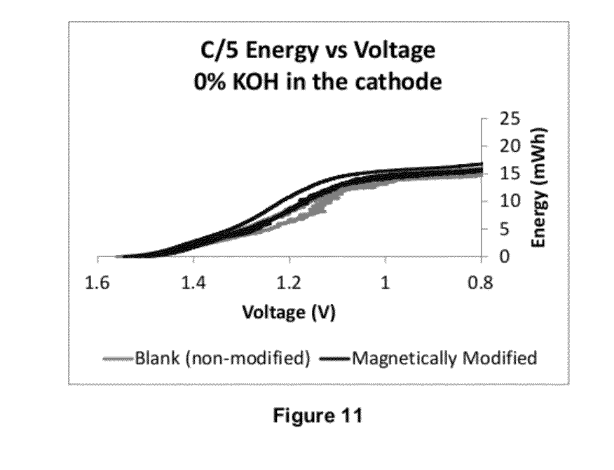

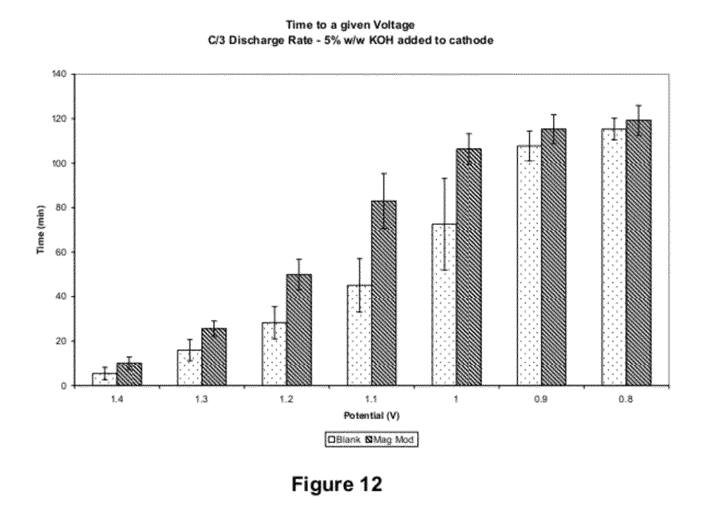

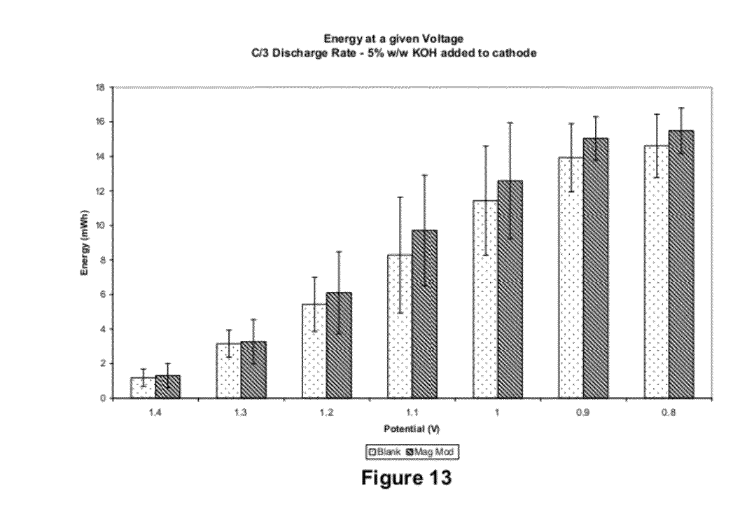

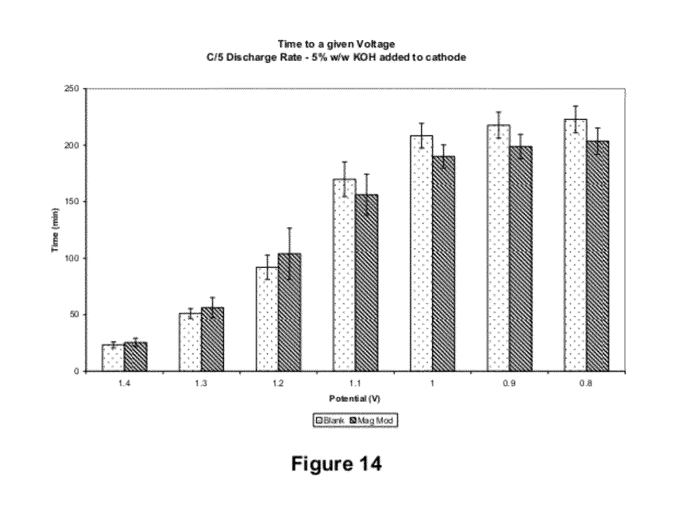

Data were summarized from the voltage versus time discharge curves and the curves for energy at a given voltage and then subjected to statistical analysis. No sieve was applied to the data. FIG. 12 illustrates time to a given voltage with a discharge rate of C/3 for batteries containing 5 w/w % KOH electrolyte in the cathode mixture. FIG. 13 illustrates time to a given voltage with a discharge rate of C/5 for batteries containing 5 w/w % KOH electrolyte in the cathode mixture. FIG. 14 illustrates time to a given voltage for batteries containing 0 w/w % KOH in the cathode mixture with a discharge rate of C/5.

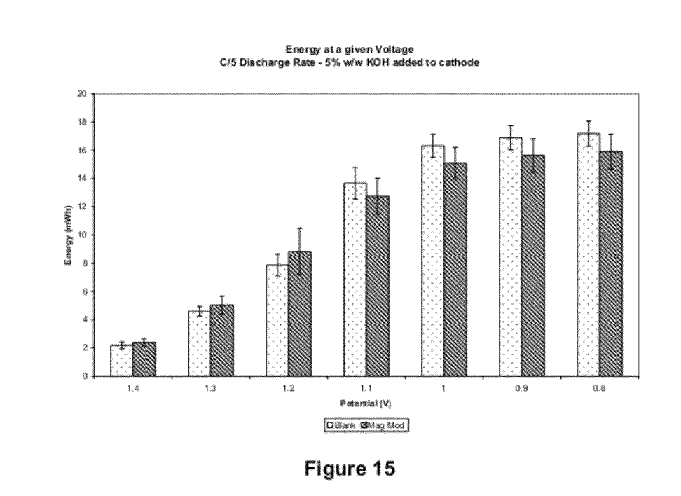

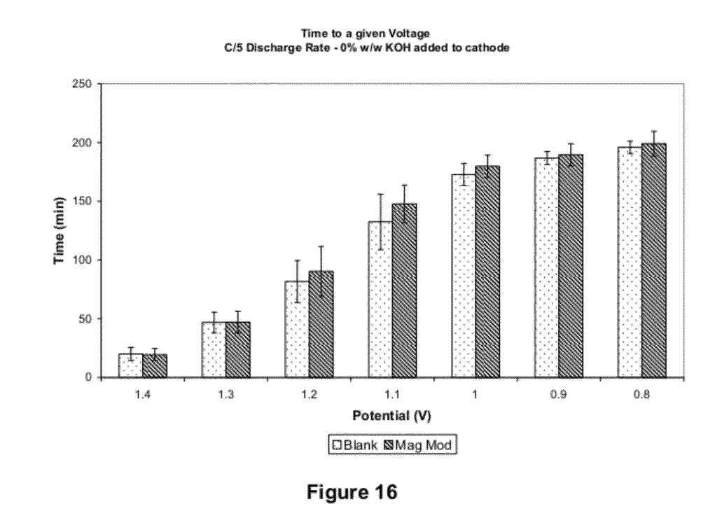

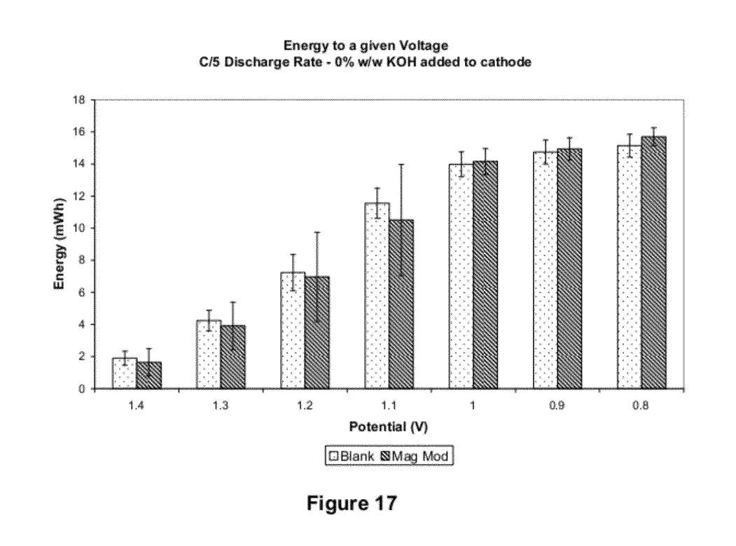

For these batteries, a cell was deemed unusable if the discharge voltage fell below 1.4 V within 15 minutes. As illustrated in FIGS. 12-17, statistics are reported for 1.4 V and 1.3 V in addition to lower voltages. Such results better resemble discharge profiles found in commercial batteries with metrics that are much more useful. All the data collected at potentials below about 1.1 V appear to be anode limited. The performance of batteries containing 0 w/w % KOH in the cathode mixture did not demonstrate strong effects from the inclusion of SmCo₅ and magnetization. Without being bound to any particular theory, this is thought to be due to the lack of electrolyte added to the cathode prior to pressing.

For this configuration (Example 2), significant increases in power, energy, and capacity were found for C/3 discharges with 5% KOH in the cathode mix. These data are shown in FIGS. 12 and 13. Data recorded at 0% and 5% KOH in the cathode mix for the slower C/5 discharge rate, FIGS. 14-17, are not statistically different with no enhancement observed in this configuration. Therefore, at lower KOH loading (5% w/w) performance is enhanced for higher rates of discharge.

In view of the above, it will be seen that several advantages of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the above description or illustrated in the figures. The invention is capable of other aspects and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. As various changes could be made in the above products and methods without departing from the scope of aspects of the invention, it is intended that all matter contained in the above description and shown in the accompanying figures shall be interpreted as illustrative and not in a limiting sense.

### REFERENCES

1. Leddy, J; Tesene, JP. US Patent Application No. “20070009771, “Batteries and battery components with magnetically modified manganese dioxide” Published 11 Jan. 2007.
2. Leddy, J; Zou, P. U.S. Pat. No. 6,890,670, “Magnetically Modified Electrodes as Well as Methods of Making and Using the Same.”
3. Zou, P; Leddy, J. “Magnetized Nickel Electrodes for Improved Charge and Discharge Rates in Nickel Metal Hydrid and Nickel Cadmium Batteries”; Electrochemical and Solid-State Letters (2006), 9(2), A43-A45.
4. Tesene, J P. MS Thesis 2005, “Magnetically-Treated Electrolytic Manganese Dioxide in Alkaline Electrolyte”; University of Iowa.
5. Zou, P, MS Thesis 2002, “Magnetic Field Effects on Nickel Electrodes for Nickel Metal Hydride Batteries”; University of Iowa.
6. Selwood, P W; Eischens, R P; Ellis, M; Wethington, K. J. Am. Chem. Soc. 1949, 71, 3039.
7. Lide, D R, Ed.; Magnetic Susceptibility of the Elements and Inorganic Compounds; CRC Handbook of Chemistry and Physics CRC Press, LLC.: 85 ed.; 2004.
8. Akiya'Kozawa, Batteries, edited by I C. V. Kordesch, 1974, Volume 1, 385-519.

1. A battery cathode mixture comprising:
a ferromagnetic material;
manganese dioxide, and
an electrolyte,
wherein the mixture is magnetized.

2. The battery cathode mixture of claim 1, wherein the ferromagnetic material is selected from the group consisting of samarium cobalt, neodymium magnet, Alnico, ferrites, magnetite, ferromagnetic materials comprising manganese, and combinations thereof.

3. The battery cathode mixture of claim 1, wherein the ferromagnetic material is in the form of microparticles.

4. The battery cathode mixture of claim 3, wherein the microparticles have an average diameter of about 100 nm to about 10 μm.

5. The battery cathode mixture of claim 3, wherein the microparticles have an average diameter of about 500 nm to about 1.5 μm.

6. The battery cathode mixture of claim 1, wherein the manganese dioxide is EMD.

7. The battery cathode mixture of claim 1, wherein the electrolyte comprises a base selected from the group consisting of KOH, LiOH, NaOH, transition metal hydroxides, and combinations thereof.

8. The battery cathode mixture of claim 1, further comprising a conductive additive selected from the group consisting of conductive carbon black, graphite, and combinations thereof.

9. The battery cathode mixture of claim 1, further comprising a binder selected from the group consisting of PVF, PVDF, PTFE, PCTFE, PFA, FEP, ETFE, ECTFE, FFPM/FFKM, FPM/FKM, PFPE, Nafion, perfluoropolyoxetane, CMC, and combinations thereof.

10. The battery cathode mixture of claim 9, wherein the binder is PTFE.

11. A battery comprising the battery cathode mixture of claim 1.

12. An electric or electronic device comprising the battery of claim 11.

13. A method for manufacturing a magnetized battery cathode mixture, comprising forming a mixture comprising a ferromagnetic material, manganese dioxide, and an electrolyte, and magnetizing the mixture.

14. The method of claim 13, wherein the ferromagnetic material is selected from the group consisting of samarium cobalt, neodymium magnet, Alnico, ferrites, magnetite, ferromagnetic materials comprising manganese, and combinations thereof.

15. The method of claim 13, wherein the ferromagnetic material is in the form of microparticles.

16. The method of claim 15, wherein the microparticles have an average diameter of about 100 nm to about 10 μm.

17. The method of claim 15, wherein the microparticles have an average diameter of about 500 nm to about 1.5 μm.

18. The method of claim 13, wherein the manganese dioxide is EMD.

19. The method of claim 13, wherein the electrolyte comprises a base selected from the group consisting of KOH, LiOH, NaOH, transition metal hydroxides, and combinations thereof.

20. The method of claim 13, wherein the mixture further comprises a conductive additive selected from the group consisting of conductive carbon black, graphite, and combinations thereof.

21. The method of claim 13, wherein the mixture further comprises a binder selected from the group consisting of PVF, PVDF, PTFE, PCTFE, PFA, FEP, ETFE, ECTFE, FFPM/FFKM, FPM/FKM, PFPE, Nafion, perfluoropolyoxetane, CMC, and combinations thereof.

22. The method of claim 13, wherein the mixture further comprises PTFE.

23. A magnetized battery cathode mixture manufactured according to the method of claim 13.

24. A method for preparing a magnetized battery cathode mixture, comprising: forming a mixture comprising an electroactive material and an electrolyte, and magnetizing the mixture.

25. The method of claim 24, wherein the electroactive material is paramagnetic.
